(19) United States
(12) Patent Application Publication
(10) Pub. No.: US 2023/0127256 A1
(43) Pub. Date: Apr. 27, 2023

(54) METHOD FOR TRANSMITTING AND RECEIVING SIGNAL IN WIRELESS COMMUNICATION SYSTEM, AND APPARATUS SUPPORTING SAME

(71) Applicant: LG ELECTRONICS INC., Seoul (KR)

(72) Inventors: Hyunsu Cha, Seoul (KR); Jeongsu Lee, Seoul (KR)

(21) Appl. No.: 17/917,325

(22) PCT Filed: Apr. 12, 2021
(86) PCT No.: PCT/KR2021/004548

§ 371 Date: Oct. 6, 2022

Related U.S. Application Data
(60) Provisional application No. 63/025,929, filed on May 15, 2020.

(30) Foreign Application Priority Data
Apr. 10, 2020 (KR) 10-2020-0044109

(51) Int. Cl. H04W 52/24; H04W 52/32; H04W 16/28

(52) U.S. Cl. CPC H04W 52/242; H04W 52/325; H04W 16/28

(57) ABSTRACT

Various embodiments relate to a next-generation wireless communication system for supporting a data transmission rate or the like higher than that of a 4th generation (4G) wireless communication system. According to various embodiments, provided are a method for transmitting and receiving a signal in a wireless communication system, and an apparatus supporting same, and various other embodiments can also be provided.

### TECHNICAL FIELD

Various embodiments are related to a wireless communication system.

### BACKGROUND ART

As a number of communication devices have required higher communication capacity, the necessity of the mobile broadband communication much improved than the existing radio access technology (RAT) has increased. In addition, massive machine type communications (MTC) capable of providing various services at anytime and anywhere by connecting a number of devices or things to each other has been considered in the next generation communication system. Moreover, a communication system design capable of supporting services/UEs sensitive to reliability and latency has been discussed.

### DISCLOSURE

### Technical Problem

Various embodiments may provide a method and apparatus for transmitting and receiving a signal in a wireless communication system.

Various embodiments may provide a method of determining/configuring transmission power for an uplink (UL) reference signal (RS) for positioning and an apparatus for supporting the method.

It will be appreciated by persons skilled in the art that the objects that could be achieved with the various embodiments are not limited to what has been particularly described hereinabove and the above and other objects that the various embodiments could achieve will be more clearly understood from the following detailed description.

### Technical Solution

Various embodiments may provide a method and apparatus for transmitting and receiving a signal in a wireless communication system.

According to various embodiments, a method performed by an apparatus in a wireless communication system may be provided.

According to various embodiments, the method may include receiving configuration information related to a sounding reference signal (SRS), and transmitting the SRS based on the configuration information.

According to various embodiments, transmission power of the SRS may be obtained based on path-loss.

According to various embodiments, based on spatial relation information for a spatial relation between a downlink (DL) reference signal (RS) and the SRS is configured, the path-loss may be obtained based on the spatial relation information.

According to various embodiments, based on the SRS is for positioning, path-loss reference configuration information is not included in the configuration information, and the spatial relation information is configured, the path-loss may be obtained based on the spatial relation information.

According to various embodiments, based on the spatial relation information is configured and an RS resource identified by the spatial relation information is not an SRS resource, the path-loss may be obtained based on the RS resource identified by the spatial relation information.

According to various embodiments, based on the spatial relation information is configured and an RS resource identified by the spatial relation information is the SRS resource, or the spatial relation information is not configured, the path-loss may be obtained based on an RS resource obtained from a synchronization signal/physical broadcast channel (SS/PBCH) block of a serving cell used to obtain a master information block (MIB) by the device.

According to various embodiments, the path-loss may be obtained based on a path-loss reference.

According to various embodiments, the path-loss reference may be obtained based on the spatial relation information.

According to various embodiments, based on the spatial relation information is configured for one or more SRS resources that are some of SRS resources included in the SRS resource set, the path-loss reference may be used for all of the SRS resources.

According to various embodiments, the path-loss reference may be obtained based on an identifier (ID) of a transmission point (TP) at which the spatial relation information and the DL RS are received.

According to various embodiments, a user equipment (UE) configured to operate in a wireless communication system may be provided.

According to various embodiments, the UE may include a transceiver, and at least one processor coupled with the transceiver.

According to various embodiments, the one or more processors may be configured to receive configuration information related to a sounding reference signal (SRS), and to transmit the SRS based on the configuration information.

According to various embodiments, transmission power of the SRS may be obtained based on path-loss.

According to various embodiments, based on spatial relation information for a spatial relation between a downlink (DL) reference signal (RS) and the SRS is configured, the path-loss may be obtained based on the spatial relation information.

According to various embodiments, based on the SRS is for positioning, path-loss reference configuration information is not included in the configuration information, and the spatial relation information is configured, the path-loss may be obtained based on the spatial relation information.

According to various embodiments, based on the spatial relation information is configured and an RS resource identified by the spatial relation information is not an SRS resource, the path-loss may be obtained based on the RS resource identified by the spatial relation information.

According to various embodiments, based on the spatial relation information is configured and an RS resource identified by the spatial relation information is the SRS resource, or the spatial relation information is not configured, the path-loss may be obtained based on an RS resource obtained from a synchronization signal/physical broadcast channel (SS/PBCH) block of a serving cell used to obtain a master information block (MIB) by the device.

According to various embodiments, the path-loss may be obtained based on a path-loss reference.

According to various embodiments, the path-loss reference may be obtained based on the spatial relation information.

According to various embodiments, the one or more processors may be configured to communicate with one or more of a mobile terminal, a network, and an autonomous driving vehicle other than a vehicle including the UE.

According to various embodiments, a method performed by an apparatus in a wireless communication system may be provided.

According to various embodiments, the method may include transmitting configuration information related to a sounding reference signal (SRS), and receiving the SRS in response to the configuration information.

According to various embodiments, transmission power of the SRS may be based on path-loss.

According to various embodiments, based on spatial relation information for a spatial relation between a downlink (DL) reference signal (RS) and the SRS is configured, the path-loss may be based on the spatial relation information.

According to various embodiments, a base station operating in a wireless communication system may be provided.

According to various embodiments, the base station may include a transceiver, and at least one processor coupled with the transceiver.

According to various embodiments, wherein the one or more processors may be configured to transmit configuration information related to a sounding reference signal (SRS), and to receive the SRS in response to the configuration information.

According to various embodiments, transmission power of the SRS may be based on path-loss.

According to various embodiments, based on spatial relation information for a spatial relation between a downlink (DL) reference signal (RS) and the SRS is configured, the path-loss may be based on the spatial relation information.

According to various embodiments, an apparatus operating in a wireless communication system may be provided.

According to various embodiments, the apparatus may include one or more processors, and one or more memories storing one or more instructions to cause the one or more processors to carry out a method.

According to various embodiments, the method may include receiving configuration information related to a sounding reference signal (SRS), and transmitting the SRS based on the configuration information.

According to various embodiments, transmission power of the SRS may be obtained based on path-loss.

According to various embodiments, based on spatial relation information for a spatial relation between a downlink (DL) reference signal (RS) and the SRS is configured, the path-loss may be obtained based on the spatial relation information.

According to various embodiments, a processor-readable medium storing one or more instructions to cause one or more processors to carry out a method may be provided.

According to various embodiments, the method may include receiving configuration information related to a sounding reference signal (SRS), and transmitting the SRS based on the configuration information.

According to various embodiments, transmission power of the SRS may be obtained based on path-loss.

According to various embodiments, based on spatial relation information for a spatial relation between a downlink (DL) reference signal (RS) and the SRS is configured, the path-loss may be obtained based on the spatial relation information.

It will be appreciated by persons skilled in the art that the effects that can be achieved with the various embodiments are not limited to what has been particularly described hereinabove and other advantages of the various embodiments will be more clearly understood from the following detailed description taken in conjunction with the accompanying drawings.

### Advantageous Effects

According to various embodiments, a signal may be effectively transmitted and received in a wireless communication system.

According to various embodiments, positioning may be effectively performed in a wireless communication system.

Various embodiments may provide a method of determining/configuring transmission power for an uplink (UL) reference signal (RS) for positioning and an apparatus for supporting the method.

Various embodiments may provide a method of determining/configuring a path-loss reference for a UL RS for positioning.

According to various embodiments, the ambiguity of an operation of a user equipment (UE) when there is no explicit configuration of a path-loss reference for a UL RS for positioning may be resolved.

According to various embodiments, a serving cell/BS/TRP as well as a neighboring cell/BS/TRP is considered together, and thus transmission power for a UL RS for positioning may be effectively determined/configured.

It will be appreciated by persons skilled in the art that the effects that can be achieved with the various embodiments are not limited to what has been particularly described hereinabove and other advantages of the various embodiments will be more clearly understood from the following detailed description taken in conjunction with the accompanying drawings.

### DESCRIPTION OF DRAWINGS

The accompanying drawings are provided to help understanding of various embodiments, along with a detailed description. However, the technical features of various embodiments are not limited to a specific drawing, and features disclosed in each drawing may be combined with each other to constitute a new embodiment. Reference numerals in each drawing denote structural elements.

FIG. 1 is a diagram illustrating physical channels and a signal transmission method using the physical channels, which may be used in various embodiments;

FIG. 2 is a diagram illustrating a radio frame structure in a new radio access technology (NR) system to which various embodiments are applicable;

FIG. 3 illustrates an exemplary resource grid to which various embodiments are applicable.

FIG. 4 is a diagram illustrating mapping of physical channels in a slot, to which various embodiments are applicable.

FIG. 5 is a diagram illustrating an exemplary uplink (UL) transmission/reception operation to which various embodiments are applicable.

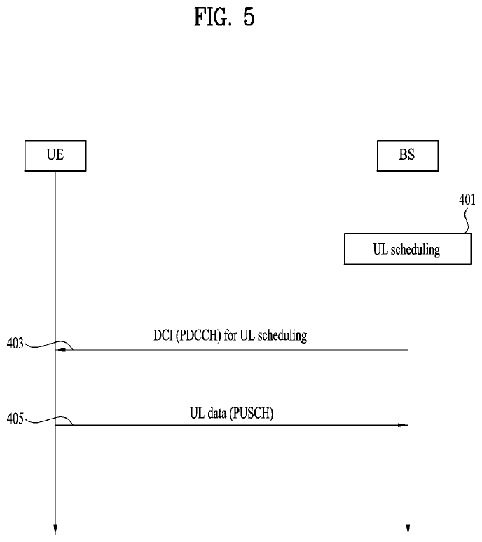

FIG. 6 is a diagram illustrating an exemplary procedure for controlling UL transmission power to which various embodiments are applicable.

FIG. 7 is a diagram illustrating a signal flow for an exemplary UL BM process using an SRS, which is applicable to various embodiments.

FIG. 8 is a diagram illustrating an exemplary UL-DL timing relationship applicable to various embodiments.

FIG. 9 is a diagram illustrating a positioning protocol configuration for positioning a user equipment (UE), to which various embodiments are applicable.

FIG. 10 illustrates an exemplary system architecture for measuring positioning of a UE to which various embodiments are applicable.

FIG. 11 illustrates an implementation example of a network for UE positioning.

FIG. 12 is a diagram illustrating protocol layers for supporting LTE positioning protocol (LPP) message transmission, to which various embodiments are applicable.

FIG. 13 is a diagram illustrating protocol layers for supporting NR positioning protocol a (NRPPa) protocol data unit (PDU) transmission, to which various embodiments are applicable.

FIG. 14 is a diagram illustrating an observed time difference of arrival (OTDOA) positioning method, to which various embodiments are applicable.

FIG. 15 is a diagram illustrating a multi-round trip time (multi-RTT) positioning method to which various embodiments are applicable.

FIG. 16 is a simplified diagram illustrating a method of operating a UE, a transmission and reception point (TRP), a location server, and/or a location management function (LMF) according to various embodiments.

FIG. 17 is a simplified diagram illustrating a method of operating a UE, a TRP, a location server, and/or an LMF according to various embodiments.

FIG. 18 is a diagram showing an example of a configuration of transmission power according to various embodiments.

FIG. 19 is a diagram schematically illustrating a method of operating a UE and a network node according to various embodiments.

FIG. 20 is a flowchart illustrating a method of operating a UE according to various embodiments.

FIG. 21 is a flowchart illustrating a method of operating a network node according to various embodiments.

FIG. 22 is a block diagram illustrating an apparatus for implementing various embodiments;

FIG. 23 illustrates an exemplary communication system to which various embodiments are applied.

FIG. 24 illustrates exemplary wireless devices to which various embodiments are applicable.

FIG. 25 illustrates other exemplary wireless devices to which various embodiments are applied.

FIG. 26 illustrates an exemplary portable device to which various embodiments are applied.

FIG. 27 illustrates an exemplary vehicle or autonomous driving vehicle to which various embodiments.

### MODE FOR DISCLOSURE

Various embodiments are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

Various embodiments are described in the context of a 3GPP communication system (e.g., including LTE, NR, 6G, and next-generation wireless communication systems) for clarity of description, to which the technical spirit of the various embodiments is not limited. For the background art, terms, and abbreviations used in the description of the various embodiments, refer to the technical specifications published before the present disclosure. For example, the documents of 3GPP TS 36.211, 3GPP TS 36.212, 3GPP TS 36.213, 3GPP TS 36.300, 3GPP TS 36.321, 3GPP TS 36.331, 3GPP TS 36.355, 3GPP TS 36.455, 3GPP TS 37.355, 3GPP TS 37.455, 3GPP TS 38.211, 3GPP TS 38.212, 3GPP TS 38.213, 3GPP TS 38.214, 3GPP TS 38.215, 3GPP TS 38.300, 3GPP TS 38.321, 3GPP TS 38.331, 3GPP TS 38.355, 3GPP TS 38.455, and so on may be referred to.

1. 3GPP System

1.1. Physical Channels and Signal Transmission and Reception

In a wireless access system, a UE receives information from a base station on a downlink (DL) and transmits information to the base station on an uplink (UL). The information transmitted and received between the UE and the base station includes general data information and various types of control information. There are many physical channels according to the types/usages of information transmitted and received between the base station and the UE.

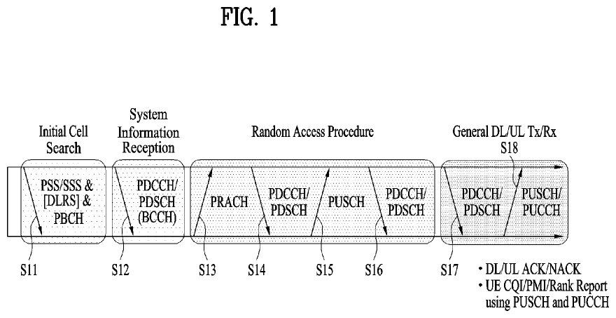

FIG. 1 is a diagram illustrating physical channels and a signal transmission method using the physical channels, which may be used in various embodiments.

When powered on or when a UE initially enters a cell, the UE performs initial cell search involving synchronization with a BS in step S11. For initial cell search, the UE receives a synchronization signal block (SSB). The SSB includes a primary synchronization signal (PSS), a secondary synchronization signal (SSS), and a physical broadcast channel (PBCH). The UE synchronizes with the BS and acquires information such as a cell Identifier (ID) based on the PSS/SSS. Then the UE may receive broadcast information from the cell on the PBCH. In the meantime, the UE may check a downlink channel status by receiving a downlink reference signal (DL RS) during initial cell search.

After initial cell search, the UE may acquire more specific system information by receiving a physical downlink control channel (PDCCH) and receiving a physical downlink shared channel (PDSCH) based on information of the PDCCH in step S12.

Subsequently, to complete connection to the eNB, the UE may perform a random access procedure with the eNB (S13 to S16). In the random access procedure, the UE may transmit a preamble on a physical random access channel (PRACH) (S13) and may receive a PDCCH and a random access response (RAR) for the preamble on a PDSCH associated with the PDCCH (S14). The UE may transmit a physical uplink shared channel (PUSCH) by using scheduling information in the RAR (S15), and perform a contention resolution procedure including reception of a PDCCH signal and a PDSCH signal corresponding to the PDCCH signal (S16).

Aside from the above 4-step random access procedure (4-step RACH procedure or type-1 random access procedure), when the random access procedure is performed in two steps (2-step RACH procedure or type-2 random access procedure), steps S13 and S15 may be performed as one UE transmission operation (e.g., an operation of transmitting message A (MsgA) including a PRACH preamble and/or a PUSCH), and steps S14 and S16 may be performed as one BS transmission operation (e.g., an operation of transmitting message B (MsgB) including an RAR and/or contention resolution information)

After the above procedure, the UE may receive a PDCCH and/or a PDSCH from the BS (S17) and transmit a PUSCH and/or a physical uplink control channel (PUCCH) to the BS (S18), in a general UL/DL signal transmission procedure.

Control information that the UE transmits to the BS is generically called uplink control information (UCI). The UCI includes a hybrid automatic repeat and request acknowledgement/negative acknowledgement (HARQ-ACK/NACK), a scheduling request (SR), a channel quality indicator (CQI), a precoding matrix index (PMI), a rank indicator (RI), etc.

In general, UCI is transmitted periodically on a PUCCH. However, if control information and traffic data should be transmitted simultaneously, the control information and traffic data may be transmitted on a PUSCH. In addition, the UCI may be transmitted aperiodically on the PUSCH, upon receipt of a request/command from a network.

1.2. Physical Resource

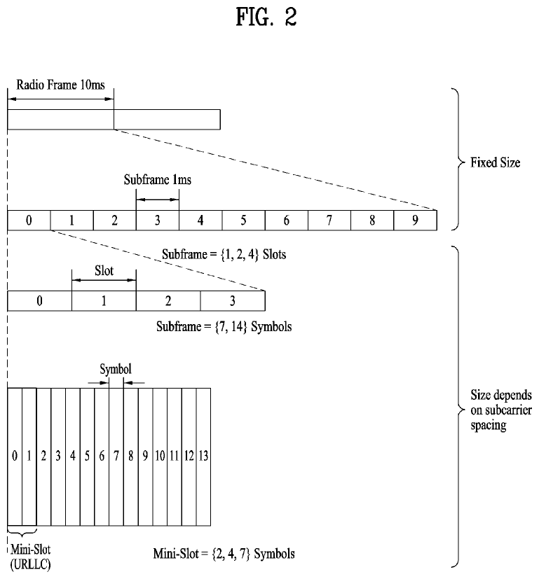

FIG. 2 is a diagram illustrating a radio frame structure in an NR system to which various embodiments are applicable.

The NR system may support multiple numerologies. A numerology may be defined by a subcarrier spacing (SCS) and a cyclic prefix (CP) overhead. Multiple SCSs may be derived by scaling a default SCS by an integer N (or μ). Further, even though it is assumed that a very small SCS is not used in a very high carrier frequency, a numerology to be used may be selected independently of the frequency band of a cell. Further, the NR system may support various frame structures according to multiple numerologies.

Now, a description will be given of OFDM numerologies and frame structures which may be considered for the NR system. Multiple OFDM numerologies supported by the NR system may be defined as listed in Table 1. For a bandwidth part (BWP), μ and a CP are obtained from RRC parameters provided by the BS.

TABLE 1

| | Δf = 2^{μ} · 15 | |
|---|---|---|
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |

In NR, multiple numerologies (e.g., SCSs) are supported to support a variety of 5G services. For example, a wide area in cellular bands is supported for an SCS of 15 kHz, a dense-urban area, a lower latency, and a wider carrier bandwidth are supported for an SCS of 30 kHz/60 kHz, and a larger bandwidth than 24.25 GHz is supported for an SCS of 60 kHz or more, to overcome phase noise.

An NR frequency band is defined by two types of frequency ranges, FR1 and FR2. FR1 may be a sub-6 GHz range, and FR2 may be an above-6 GHz range, that is, a millimeter wave (mmWave) band.

Table 2 below defines the NR frequency band, by way of example.

TABLE 2

| Frequency range | Corresponding | | |
|---|---|---|---|
| designation | frequency range | Subcarrier Spacing | |
| FR1 | 410 MHz-7125 MHz | 15, 30, 60 | kHz |
| FR2 | 24250 MHz-52600 MHz | 60, 120, 240 | kHz |

Regarding a frame structure in the NR system, the time-domain sizes of various fields are represented as multiples of a basic time unit for NR, T_{c}=1/(Δfₘₐₓ*N_{f}) where Δfₘₐₓ=480*10³ Hz and a value N_{f} related to a fast Fourier transform (FFT) size or an inverse fast Fourier transform (IFFT) size is given as N_{f}=4096. T_{c} and Tₛ which is an LTE-based time unit and sampling time, given as Tₛ=1/((15 kHz)*2048) are placed in the following relationship: Tₛ/T_{c}=64. DL and UL transmissions are organized into (radio) frames each having a duration of T_{f}=(Δfₘₐₓ*N_{f}/100)*T_{c}=10 ms. Each radio frame includes 10 subframes each having a duration of T_{sf}=(Δfₘₐₓ*N_{f}/1000)*T_{c}=1 ms. There may exist one set of frames for UL and one set of frames for DL. For a numerology μ, slots are numbered with n^{μ}ₛϵ{0, . . . ,N^{slot,μ}_{frame}−1} in an increasing order in a subframe, and with n^{μ}_{s,f}ϵ{0, . . . ,N^{slot,μ}_{frame}−1} in an increasing order in a radio frame. One slot includes N^{μ}_{symb} consecutive OFDM symbols, and N^{μ}_{symb} depends on a CP. The start of a slot n^{μ}ₛ in a subframe is aligned in time with the start of an OFDM symbol n^{μ}ₛ*N^{μ}_{symb} in the same subframe.

Table 3 lists the number of symbols per slot, the number of slots per frame, and the number of slots per subframe, for each SCS in a normal CP case, and Table 4 lists the number of symbols per slot, the number of slots per frame, and the number of slots per subframe, for each SCS in an extended CP case.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

In the above tables, N^{slot}_{symb} represents the number of symbols in a slot, N^{frame,μ}ₛₗₒₜ represents the number of slots in a frame, and N^{subframe,μ}ₛₗₒₜ represents the number of slots in a subframe.

In the NR system to which various embodiments are applicable, different OFDM(A) numerologies (e.g., SCSs, CP lengths, and so on) may be configured for a plurality of cells which are aggregated for one UE. Accordingly, the (absolute time) period of a time resource including the same number of symbols (e.g., a subframe (SF), a slot, or a TTI) (generically referred to as a time unit (TU), for convenience) may be configured differently for the aggregated cells.

FIG. 2 illustrates an example with μ=2 (i.e., an SCS of 60 kHz), in which referring to Table 6, one subframe may include four slots. One subframe={1, 2, 4} slots in FIG. 2, which is exemplary, and the number of slot(s) which may be included in one subframe is defined as listed in Table 3 or Table 4.

Further, a mini-slot may include 2, 4 or 7 symbols, fewer symbols than 2, or more symbols than 7.

Regarding physical resources in the NR system, antenna ports, a resource grid, resource elements (REs), resource blocks (RBs), carrier parts, and so one may be considered. The physical resources in the NR system will be described below in detail.

An antenna port is defined such that a channel conveying a symbol on an antenna port may be inferred from a channel conveying another symbol on the same antenna port. When the large-scale properties of a channel carrying a symbol on one antenna port may be inferred from a channel carrying a symbol on another antenna port, the two antenna ports may be said to be in a quasi co-located or quasi co-location (QCL) relationship. The large-scale properties include one or more of delay spread, Doppler spread, frequency shift, average received power, received timing, average delay, and a spatial reception (Rx) parameter. The spatial Rx parameter refers to a spatial (Rx) channel property parameter such as an angle of arrival.

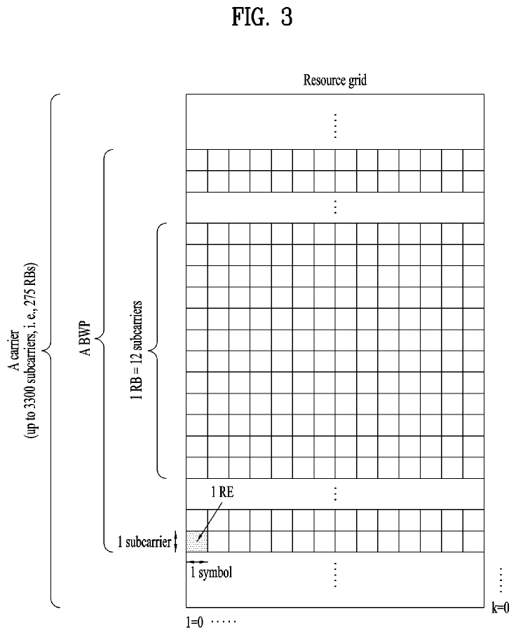

FIG. 3 illustrates an exemplary resource grid to which various embodiments are applicable.

Referring to FIG. 3, for each subcarrier spacing (SCS) and carrier, a resource grid is defined as 14×2^{μ} OFDM symbols by N_{grid}^{size,μ}×N_{SC}^{RB} subcarriers, where N_{grid}^{size,μ} is indicated by RRC signaling from the BS. N_{grid}^{size,μ} may vary according to an SCS configuration μ and a transmission direction, UL or DL. There is one resource grid for an SCS configuration μ, an antenna port p, and a transmission direction (UL or DL). Each element of the resource grid for the SCS configuration u and the antenna port p is referred to as an RE and uniquely identified by an index pair (k, l) where k represents an index in the frequency domain, and l represents a symbol position in the frequency domain relative to a reference point. The RE (k, l) for the SCS configuration μ and the antenna port p corresponds to a physical resource and a complex value a_{k,l}^{(p,μ)}. An RB is defined as N_{SC}^{RB}=12 consecutive subcarriers in the frequency domain.

Considering that the UE may not be capable of supporting a wide bandwidth supported in the NR system, the UE may be configured to operate in a part (bandwidth part (BWP)) of the frequency bandwidth of a cell.

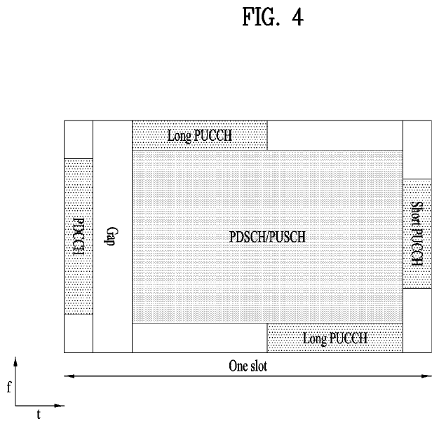

FIG. 4 is a diagram illustrating exemplary mapping of physical channels in a slot, to which various embodiments are applicable.

One slot may include all of a DL control channel, DL or UL data, and a UL control channel. For example, the first N symbols of a slot may be used to transmit a DL control channel (hereinafter, referred to as a DL control region), and the last M symbols of the slot may be used to transmit a UL control channel (hereinafter, referred to as a UL control region). Each of N and M is an integer equal to or larger than 0. A resource area (hereinafter, referred to as a data region) between the DL control region and the UL control region may be used to transmit DL data or UL data. There may be a time gap for DL-to-UL or UL-to-DL switching between a control region and a data region. A PDCCH may be transmitted in the DL control region, and a PDSCH may be transmitted in the DL data region. Some symbols at a DL-to-UL switching time in the slot may be used as the time gap.

The BS transmits related signals to the UE on DL channels as described below, and the UE receives the related signals from the BS on the DL channels.

The PDSCH conveys DL data (e.g., DL-shared channel transport block (DL-SCH TB)) and uses a modulation scheme such as quadrature phase shift keying (QPSK), 16-ary quadrature amplitude modulation (16QAM), 64QAM, or 256QAM. A TB is encoded into a codeword. The PDSCH may deliver up to two codewords. Scrambling and modulation mapping are performed on a codeword basis, and modulation symbols generated from each codeword are mapped to one or more layers (layer mapping). Each layer together with a demodulation reference signal (DMRS) is mapped to resources, generated as an OFDM symbol signal, and transmitted through a corresponding antenna port.

The PDCCH may deliver downlink control information (DCI), for example, DL data scheduling information, UL data scheduling information, and so on. The PUCCH may deliver uplink control information (UCI), for example, an acknowledgement/negative acknowledgement (ACK/NACK) information for DL data, channel state information (CSI), a scheduling request (SR), and so on.

The PDCCH carries downlink control information (DCI) and is modulated in quadrature phase shift keying (QPSK). One PDCCH includes 1, 2, 4, 8, or 16 control channel elements (CCEs) according to an aggregation level (AL). One CCE includes 6 resource element groups (REGs). One REG is defined by one OFDM symbol by one (P)RB.

The PDCCH is transmitted in a control resource set (CORESET). A CORESET is defined as a set of REGs having a given numerology (e.g., SCS, CP length, and so on). A plurality of CORESETs for one UE may overlap with each other in the time/frequency domain. A CORESET may be configured by system information (e.g., a master information block (MIB)) or by UE-specific higher layer (RRC) signaling. Specifically, the number of RBs and the number of symbols (up to 3 symbols) included in a CORESET may be configured by higher-layer signaling.

The UE acquires DCI delivered on a PDCCH by decoding (so-called blind decoding) a set of PDCCH candidates. A set of PDCCH candidates decoded by a UE are defined as a PDCCH search space set. A search space set may be a common search space (CSS) or a UE-specific search space (USS). The UE may acquire DCI by monitoring PDCCH candidates in one or more search space sets configured by an MIB or higher-layer signaling.

The UE transmits related signals on later-described UL channels to the BS, and the BS receives the related signals on the UL channels from the UE.

The PUSCH delivers UL data (e.g., a UL-shared channel transport block (UL-SCH TB)) and/or UCI, in cyclic prefix-orthogonal frequency division multiplexing (CP-OFDM) waveforms or discrete Fourier transform-spread-orthogonal division multiplexing (DFT-s-OFDM) waveforms. If the PUSCH is transmitted in DFT-s-OFDM waveforms, the UE transmits the PUSCH by applying transform precoding. For example, if transform precoding is impossible (e.g., transform precoding is disabled), the UE may transmit the PUSCH in CP-OFDM waveforms, and if transform precoding is possible (e.g., transform precoding is enabled), the UE may transmit the PUSCH in CP-OFDM waveforms or DFT-s-OFDM waveforms. The PUSCH transmission may be scheduled dynamically by a UL grant in DCI or semi-statically by higher-layer signaling (e.g., RRC signaling) (and/or layer 1 (L1) signaling (e.g., a PDCCH)) (a configured grant). The PUSCH transmission may be performed in a codebook-based or non-codebook-based manner.

The PUCCH delivers UCI, an HARQ-ACK, and/or an SR and is classified as a short PUCCH or a long PUCCH according to the transmission duration of the PUCCH.

1.3. Uplink Transmission/Reception Operation

FIG. 4 is a diagram illustrating an exemplary uplink transmission/reception operation to which various embodiments are applicable.
The BS schedules UL transmission in relation to, for example, frequency/time resources, a transport layer, a UL precoder, and an MCS (401). In particular, the BS may determine, through the above-described operations, a beam for PUSCH transmission of the UE.
The UE receives DCI for UL scheduling (including scheduling information about the PUSCH) from the BS on the PDCCH (403).

DCI format 0_0 or 0_1 may be used for UL scheduling. In particular, DCI format 0_1 includes the following information: an identifier for DCI formats, a UL/supplementary UL (SUL), a bandwidth part indicator, frequency domain resource assignment, time domain resource assignment, a frequency hopping flag, a modulation and coding scheme (MCS), an SRS resource indicator (SRI), precoding information and number of layers, antenna port(s), an SRS request, DMRS sequence initialization, and UL shared channel (UL-SCH) indicator.

In particular, SRS resources configured in an SRS resource set associated with the higher layer parameter ‘usage’ may be indicated by the SRS resource indicator field. In addition, ‘spatialRelationInfo’ may be configured for each SRS resource, and the value thereof may be one of {CRI, SSB, SRI}.
The UE transmits UL data to the BS on PUSCH (405).

When the UE detects a PDCCH including DCI format 0_0 or 0_1, it transmits the PUSCH according to an indication by the DCI.

For PUSCH transmission, two transmission schemes are supported: codebook-based transmission and non-codebook-based transmission:

i) When the higher layer parameter ‘txConfig’ is set to ‘codebook’, the UE is configured for codebook-based transmission. On the other hand, when the higher layer parameter ‘txConfig’ is set to ‘nonCodebook’, the UE is configured for non-codebook based transmission. When the higher layer parameter ‘txConfig’ is not configured, the UE does not expect scheduling by DCI format 0_1. When the PUSCH is scheduled according to DCI format 0_0, PUSCH transmission is based on a single antenna port.

In the case of codebook-based transmission, the PUSCH may be scheduled by DCI format 0_0 or DCI format 0_1, or scheduled semi-statically. When the PUSCH is scheduled by DCI format 0_1, the UE determines the PUSCH transmission precoder based on the SRI, transmit precoding matrix indicator (TPMI) and transmission rank from the DCI, as given by the SRS resource indicator field and the precoding information and number of layers field. The TPMI is used to indicate a precoder to be applied across antenna ports, and corresponds to an SRS resource selected by the SRI when multiple SRS resources are configured. Alternatively, when a single SRS resource is configured, the TPMI is used to indicate a precoder to be applied across antenna ports, and corresponds to the single SRS resource. A transmission precoder is selected from the UL codebook having the same number of antenna ports as the higher layer parameter ‘nrofSRS-Ports’. When the higher layer in which the UE is set to ‘codebook’ is configured with the parameter ‘txConfig’, at least one SRS resource is configured for the UE. The SRI indicated in slot n is associated with the most recent transmission of the SRS resource identified by the SRI, where the SRS resource precedes the PDCCH carrying the SRI (i.e., slot n).

ii) In the case of non-codebook-based transmission, the PUSCH may be scheduled by DCI format 0_0 or DCI format 0_1, or scheduled semi-statically. When multiple SRS resources are configured, the UE may determine the PUSCH precoder and transmission rank based on the wideband SRI. Here, the SRI is given by the SRS resource indicator in the DCI or by the higher layer parameter ‘srs-ResourceIndicator’. The UE may use one or multiple SRS resources for SRS transmission. Here, the number of SRS resources may be configured for simultaneous transmission within the same RB based on UE capability. Only one SRS port is configured for each SRS resource. Only one SRS resource may be configured by the higher layer parameter ‘usage’ set to ‘nonCodebook’. The maximum number of SRS resources that may be configured for non-codebook-based UL transmission is 4. The SRI indicated in slot n is associated with the most recent transmission of the SRS resource identified by the SRI, where the SRS transmission precedes the PDCCH carrying the SRI (i.e., slot n).

1.4. Uplink Power Control

In wireless communication systems, it may be necessary to increase or decrease the transmission power of a UE and/or a mobile device depending on situations. Controlling the transmission power of the UE and/or mobile device may be referred to as UL power control. For example, transmission power control may be applied to satisfy requirements (e.g., signal-to-noise ratio (SNR), bit error ratio (BER), block error ratio (BLER), etc.) of a BS (e.g., gNB, eNB, etc.).

The above-described power control may be performed according to an open-loop power control method and a closed-loop power control method.

Specifically, the open-loop power control method refers to a method of controlling transmission power without feedback from a transmitting device (e.g., BS, etc.) to a receiving device (e.g., UE, etc.) and/or feedback from the receiving device to the transmitting device. For example, the UE may receive a specific channel/signal (pilot channel/signal) from the BS and estimate the strength of received power based on the received channel/signal. Then, the UE may control the transmission power based on the strength of the estimated received power.

On the other hand, the closed-loop power control method refers to a method of controlling transmission power based on feedback from a transmitting device to a receiving device and/or feedback from the receiving device to the transmitting device. For example, the BS receives a specific channel/signal from the UE and determines an optimal power level of the UE based on a power level, SNR, BER, BLER, etc. which are measured based on the received specific channel/signal. The BS may transmit information (i.e., feedback) on the determined optimal power level to the UE on a control channel, and the UE may control the transmission power based on the feedback provided by the BS.

Hereinafter, power control methods for cases in which a UE and/or a mobile device perform UL transmission to a BS in a wireless communication system will be described in detail. Specifically, power control methods for transmission of: 1) a UL data channel (e.g., PUSCH); 2) a UL control channel (e.g., PUCCH); 3) an SRS; and/or 4) a random access channel (e.g., PRACH) will be described. In this case, a transmission occasion (i.e., transmission time unit) (i) for the PUSCH, PUCCH, SRS and/or PRACH may be defined by a slot index (n_s) in a frame with a system frame number (SFN), a first symbol (S) in a slot, the number of consecutive symbols (L), and the like.

Power Control of UL Data Channel

Regarding power control of a UL data channel, a power control method will be described based on a case in which the UE performs PUSCH transmission, for convenience of description. However, the power control method is not limited to the PUSCH transmission, that is, the power control method may be extended and applied to other UL data channels supported in wireless communication systems.

For PUSCH transmission in an active UL bandwidth part (BWP) of a carrier (f) of a serving cell (c), the UE may calculate a linear power value of transmission power determined by Equation 1 below. Thereafter, the corresponding UE may control the transmission power by taking the calculated linear power value into consideration for the number of antenna ports and/or the number of SRS ports.

In particular, if the UE performs PUSCH transmission in the active UL BWP (b) of the carrier (f) of the serving cell (c) using a parameter set configuration based on index j and a PUSCH power control adjustment state based on index 1, the UE may determine PUSCH transmission power P_{PUSCH,b,f,c}(i,j,q_{d},l) (dBm) on a PUSCH transmission occasion (i) based on Equation 1 below.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i ) + {f}_{b , f , c} ( i , l )\end{matrix}\end{matrix} \} \qquad [ Equation 1 ]$$

In Equation 1, index j denotes the index for an open-loop power control parameter (e.g., P_o, alpha (a), etc.), and a maximum of 32 parameter sets may be configured for each cell. Index q_d denotes the index of a DL RS resource for path loss (PL) measurement (e.g., PL_{b,f,c}(q_{d})), and a maximum of four measurements may be configured for each cell. Index denotes the index of a closed-loop power control process, and a maximum of two processes may be configured for each cell.

In addition, P_o (e.g., P_{O_PUSCH,b,f,c}(j)) is a parameter broadcast as part of system information and may denote target received power of a receiver. The corresponding P_o value may be configured in consideration of UE throughput, cell capacity, noise and/or interference. Alpha (e.g., α_{b,f,c}(j)) may denote a rate for compensating for PL. Alpha may have a value from 0 to 1, and full path loss compensation or fractional path loss compensation may be performed according to the configured value. In this case, the alpha value may be configured in consideration of interference between UEs and/or data rates. In addition, P_{CMAX,f,c}(i) may denote configured UE transmission (or transmit) power. For example, the configured UE transmission (or transmit) power may be interpreted as ‘configured maximum UE output power’ defined in 3GPP TS 38.101-1 and/or TS 38.101-2. M_{RB,b,f,c}^{PUSCH} (i) may denote a PUSCH resource allocation bandwidth, which is expressed by the number of resource blocks (RBs) in the PUSCH transmission occasion based on an SCS (μ). f_{b,f,c}(i,l), which is related to PUSCH power control adjustment states, may be configured or indicated based on a TPC command field of DCI (e.g., DCI format 0_0, DCI format 0_1, DCI format 2_2, DCI format2_3, etc.).

In this case, a specific radio resource control (RRC) parameter (e.g., SRI-PUSCHPowerControl-Mapping, etc.) may indicate a linkage relationship between an SRS resource indicator (SRI) field of the DCI and the aforementioned indices: j, q_d, and l. In other words, the above-mentioned indices j, l, and q_d may be associated with a beam, a panel, and/or a spatial domain transmission filter based on specific information. Therefore, PUSCH transmission power control may be performed at the level of beams, panels, and/or spatial domain transmission filters.

The above-described parameters and/or information for PUSCH power control may be configured separately (independently) for each BWP. In this case, the corresponding parameters and/or information may be configured or indicated by higher layer signaling (RRC signaling, medium access control-control element (MAC-CE), etc.) and/or DCI. For example, the parameters and/or information for PUSCH power control may be provided by RRC signaling such as PUSCH-ConfigCommon, PUSCH-PowerControl, etc. The configurations of PUSCH-ConfigCommon and PUSCH-PowerControl may be defined as following table 5, and a detailed definition of each parameter may be found in 3GPP TS Rel.16 38.331.

TABLE 5

| | |
|---|---|
| PUSCH-ConfigCommon ::= | SEQUENCE { |
| groupHoppingEnabledTransformPrecoding | ENUMERATED {enabled} |

OPTIONAL, -- Need R

| | |
|---|---|
| pusch-TimeDomainAllocationList | PUSCH- |

```
    TimeDomainResourceAllocationList
    OPTIONAL, -- Need R
```

| | |
|---|---|
| msg3-DeltaPreamble | INTEGER (−1..6) |

OPTIONAL, -- Need R

| | |
|---|---|
| p0-NominalWithGrant | INTEGER (−202..24) |

```
    OPTIONAL, -- Need R
    ...
    }
```

| | |
|---|---|
| PUSCH-PowerControl ::= | SEQUENCE { |
| tpc-Accumulation | ENUMERATED { disabled } |

OPTIONAL, -- Need S

| | |
|---|---|
| msg3-Alpha | Alpha |

OPTIONAL, -- Need S

| | |
|---|---|
| p0-NominalWithoutGrant | INTEGER (−202..24) |

OPTIONAL, -- Need M

| | |
|---|---|
| p0-AlphaSets | SEQUENCE (SIZE (1..maxNrofP0- |

| | |
|---|---|
| PUSCH-AlphaSets)) OF P0-PUSCH-AlphaSet | OPTIONAL, -- Need M |

| | |
|---|---|
| pathlossReferenceRSToAddModList | SEQUENCE (SIZE |

```
    (1..maxNrofPUSCH-PathlossReferenceRSs)) OF PUSCH-PathlossReferenceRS
    OPTIONAL, -- Need N
```

| | |
|---|---|
| pathlossReferenceRSToReleaseList | SEQUENCE (SIZE |

```
    (1..maxNrofPUSCH-PathlossReferenceRSs)) OF PUSCH-PathlossReferenceRS-Id
    OPTIONAL, -- Need N
```

| | |
|---|---|
| twoPUSCH-PC-AdjustmentStates | ENUMERATED {twoStates} |

OPTIONAL, -- Need S

| | |
|---|---|
| deltaMCS | ENUMERATED {enabled} |

OPTIONAL, -- Need S

| | |
|---|---|
| sri-PUSCH-MappingToAddModList | SEQUENCE (SIZE |

```
    (1..maxNrofSRI-PUSCH-Mappings)) OF SRI-PUSCH-PowerControl
  OPTIONAL, -- Need N
```

| | |
|---|---|
| sri-PUSCH-MappingToReleaseList | SEQUENCE (SIZE (1..maxNrofSRI- |

```
PUSCH-Mappings)) OF SRI-PUSCH-PowerControlId
  OPTIONAL -- Need N
  }
```

The UE may determine or calculate the PUSCH transmission power according to the above-described method and transmit the PUSCH based on the determined or calculated PUSCH transmission power.

Power Control of UL Control Channel

Regarding power control of a UL control channel, a power control method will be described based on a case in which the UE performs PUCCH transmission, for convenience of description. However, the power control method is not limited to the PUCCH transmission, that is, the power control method may be extended and applied to other UL control channels supported in wireless communication systems.

If the UE performs PUCCH transmission in an active UL BWP (b) of a carrier (f) of a primary cell (or secondary cell) (c) using a PUCCH power control adjustment state based on index l, the UE may determine PUCCH transmission power P_{PUCCH,b,f,c}(i,qᵤ,q_{d},l) (dBm) on a PUCCH transmission occasion (i) based on Equation 2 below.

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} ( i ) + {g}_{b , f , c} ( i , l )\end{matrix}\end{matrix} \} \qquad [ Equation 2 ]$$

In Equation 2, q_u denotes the index of an open-loop power control parameter (e.g., P_o, etc.), and a maximum of 8 parameter values may be configured for each cell. Index q_d denotes the index of a DL RS resource for PL measurement (e.g., PL_{b,f,c}(q_{d}), and a maximum of four measurements may be configured for each cell. Index 1 denotes the index of a closed-loop power control process, and a maximum of two processes may be configured for each cell.

In addition, P_o (e.g., P_{O_PUCCH,b,f,c}(qᵤ)) is a parameter broadcast as part of system information and may denote target received power of a receiver. The corresponding P_o value may be configured in consideration of UE throughput, cell capacity, noise and/or interference. In addition, P_{CMAX,f,c}(i) may denote configured UE transmission (or transmit) power. For example, the configured UE transmission (or transmit) power may be interpreted as ‘configured maximum UE output power’ defined in 3GPP TS 38.101-1 and/or TS 38.101-2. M_{RB,b,f,c}^{PUCCH}(i) may denote a PUCCH resource allocation bandwidth, which is expressed by the number of RBs in the PUCCH transmission occasion based on an SCS (μ). Delta functions (e.g., Δ_{F_PUCCH}(F), Δ_{TF,b,f,c}(i) etc.) may be configured in consideration of PUCCH formats (e.g., PUCCH formats 0, 1, 2, 3, 4, etc.). g_{b,f,c}(i,l), which is related to PUCCH power control adjustment states, may be configured or indicated based on a TPC command field of DCI received or detected by the UE (e.g., DCI format 1_0, DCI format 1_1, DCI format 2_2, etc.).

In this case, a specific RRC parameter (e.g., PUCCH-SpatialRelationInfo, etc.) and/or a specific MAC-CE command (e.g., PUCCH spatial relation Activation/Deactivation, etc.) may be used to activate or deactivate a linkage relationship between PUCCH resources and the aforementioned indices q_u, q_d, and l. For example, the PUCCH spatial relation Activation/Deactivation command of the MAC-CE may activate or deactivate the linkage relationship between the PUCCH resources and the aforementioned indices q_u, q_d, and l based on the RRC parameter PUCCH-SpatialRelationInfo. In other words, the above-described indices q_u, q_d, and l may be associated with a beam, a panel, and/or a spatial domain transmission filter based on specific information. Therefore, PUCCH transmission power control may be performed at the level of beams, panels, and/or spatial domain transmission filters.

The above-described parameters and/or information for PUCCH power control may be configured separately (independently) for each BWP. In this case, the corresponding parameters and/or information may be configured or indicated by higher layer signaling (RRC signaling, MAC-CE, etc.) and/or DCI. For example, the parameters and/or information for PUCCH power control may be provided by RRC signaling such as PUCCH-ConfigCommon, PUCCH-PowerControl, etc. The configurations of PUCCH-ConfigCommon and PUCCH-PowerControl may be defined as following table 6, and a detailed definition of each parameter may be found in 3GPP TS Rel.16 38.331.

TABLE 6

| | |
|---|---|
| PUCCH-ConfigCommon ::= | SEQUENCE { |
| pucch-ResourceCommon | INTEGER (0..15) |

OPTIONAL, -- Cond InitialBWP-Only

| | |
|---|---|
| pucch-GroupHopping | ENUMERATED { neither, enable, |

disable },

| | |
|---|---|
| hoppingId | INTEGER (0..1023) |

OPTIONAL, -- Need R

| | |
|---|---|
| p0-nominal | INTEGER (−202..24) |

```
OPTIONAL, -- Need R
  ...
  }
```

| | |
|---|---|
| PUCCH-PowerControl ::= | SEQUENCE { |
| deltaF-PUCCH-f0 | INTEGER (−16..15) |

OPTIONAL, -- Need R

| | |
|---|---|
| deltaF-PUCCH-f1 | INTEGER (−16..15) |

OPTIONAL, -- Need R

| | |
|---|---|
| deltaF-PUCCH-f2 | INTEGER (−16..15) |

OPTIONAL, -- Need R

| | |
|---|---|
| deltaF-PUCCH-f3 | INTEGER (−16..15) |

OPTIONAL, -- Need R

| | |
|---|---|
| deltaF-PUCCH-f4 | INTEGER (−16..15) |

OPTIONAL, -- Need R

| | |
|---|---|
| p0-Set | SEQUENCE (SIZE |

| | |
|---|---|
| (1..maxNrofPUCCH-P0-PerSet)) OF P0-PUCCH | OPTIONAL, -- |

Need M

| | |
|---|---|
| pathlossReferenceRSs | SEQUENCE (SIZE |

(1..maxNrofPUCCH-PathlossReferenceRSs)) OF PUCCH-PathlossReferenceRS
OPTIONAL, -- Need M

| | |
|---|---|
| twoPUCCH-PC-AdjustmentStates | ENUMERATED {twoStates} |

```
OPTIONAL, -- Need S
  ...
  }
```

| | |
|---|---|
| P0-PUCCH ::= | SEQUENCE { |
| p0-PUCCH-Id | P0-PUCCH-Id, |
| p0-PUCCH-Value | INTEGER (−16..15) |

}

| | |
|---|---|
| P0-PUCCH-Id ::= | INTEGER (1..8) |
| PUCCH-PathlossReferenceRS ::= | SEQUENCE { |
| pucch-PathlossReferenceRS-Id | PUCCH- |

PathlossReferenceRS-Id,

| | |
|---|---|
| referenceSignal | CHOICE { |
| ssb-Index | SSB-Index, |
| csi-RS-Index | NZP-CSI-RS-ResourceId |

```
  }
  }
```

The UE may determine or calculate the PUCCH transmission power according to the above-described method and transmit the PUCCH based on the determined or calculated PUCCH transmission power.

Power Control of SRS

In relation to SRS transmission in an active UL BWP of a carrier (f) of a serving cell (c), the UE may calculate a linear power value of transmission power determined by Equation 3 below. Thereafter, the UE may control the transmission power by equally dividing the calculated linear power value over antenna port(s) configured for the SRS.

Specifically, when the UE performs SRS transmission in an active UL BWP (b) of the carrier (f) of the serving cell (c) using an SRS power control adjustment state based on index l, the UE may determine SRS transmission power P_{SRS,b,f,c}(i,qₛ,l) (dBm) on an SRS transmission occasion (i) based on Equation 3 below.

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} \qquad [ Equation 3 ]$$

In Equation 3, q_s denotes the index of an open-loop power control parameter (e.g., P_o, alpha (α), a DL RS resource for a path loss (PL) measurement (e.g., PL_{b,f,c}(q_{d})), etc.), which may be configured for SRS resource set. Index l denotes the index of a closed-loop power control process, and the corresponding index may be configured independently of a PUSCH or configured in relation to the PUSCH. If SRS power control is not related to the PUSCH, the maximum number of closed-loop power control processes for the SRS may be 1.

In addition, P_o (e.g., P_{O_SRS,b,f,c}(qₛ)) is a parameter broadcast as part of system information and may denote target received power of the receiver. The corresponding P_o value may be configured in consideration of UE throughput, cell capacity, noise and/or interference, etc. Alpha (e.g., α_{SRS,b,f,c}(qₛ)) may denote a rate for compensating for PL. Alpha may have a value from 0 to 1, and full path loss compensation or fractional path loss compensation may be performed according to the configured value. In this case, the alpha value may be configured in consideration of interference between UEs and/or data rates. In addition, P_{CMAX,f,c}(i) may denote configured UE transmission power. For example, the configured UE transmission power may be interpreted as ‘configured maximum UE output power’ defined in 3GPP TS 38.101-1 and/or TS 38.101-2. M_{sRS,b,f,c}(i) may denote an SRS resource allocation bandwidth, which is expressed by the number of RBs in the SRS transmission occasion based on an SCS (μ). In addition, h_{b,f,c}(i,l), which is related to SRS power control adjustment states, may be configured or indicated based on a TPC command field of DCI received or detected by the UE (e.g., DCI format 2_3, etc.) and/or an RRC parameter (e.g., srs-PowerControlAdjustmentStates, etc.).

A resource for SRS transmission may be applied as a reference for the BS and/or UE to determine a beam, a panel, and/or a spatial domain transmission filter. Thus, SRS transmission power control may be performed in units of beams, panels, and/or spatial domain transmission filters.

The above-described parameters and/or information for SRS power control may be configured separately (independently) for each BWP. In this case, the corresponding parameters and/or information may be configured or indicated by higher layer signaling (e.g., RRC signaling, MAC-CE, etc.) and/or DCI. For example, the parameters and/or information for SRS power control may be provided by RRC signaling such as SRS-Config, SRS-TPC-CommandConfig, etc. Table 7 below shows the configurations of SRS-Config and SRS-TPC-CommandConfig. The definition and details of each parameter may be found in 3GPP TS Rel.16 38.331.

TABLE 7

| | |
|---|---|
| SRS-Config ::= | SEQUENCE { |
| srs-ResourceSetToReleaseList | SEQUENCE |

| | |
|---|---|
| (SIZE(1..maxNrofSRS-ResourceSets)) OF SRS-ResourceSetId | OPTIONAL, - |

- Need N

| | |
|---|---|
| srs-ResourceSetToAddModList | SEQUENCE |

| | |
|---|---|
| (SIZE(1..maxNrofSRS-ResourceSets)) OF SRS-ResourceSet | OPTIONAL, - |

- Need N

| | |
|---|---|
| srs-ResourceToReleaseList | SEQUENCE |

| | |
|---|---|
| (SIZE(1..maxNrofSRS-Resources)) OF SRS-ResourceId | OPTIONAL, |

-- Need N

| | |
|---|---|
| srs-ResourceToAddModList | SEQUENCE |

| | |
|---|---|
| (SIZE(1..maxNrofSRS-Resources)) OF SRS-Resource | OPTIONAL, |

-- Need N

| | |
|---|---|
| tpc-Accumulation | ENUMERATED {disabled} |

OPTIONAL, -- Need S
...,

| | |
|---|---|
| SRS-ResourceSet ::= | SEQUENCE { |
| srs-ResourceSetId | SRS-ResourceSetId, |
| srs-ResourceIdList | SEQUENCE |

| | |
|---|---|
| (SIZE(1..maxNrofSRS-ResourcesPerSet)) OF SRS-ResourceId | OPTIONAL, -- |

Cond Setup

| | |
|---|---|
| resourceType | CHOICE { |
| aperiodic | SEQUENCE { |
| aperiodicSRS-ResourceTrigger | INTEGER (1..maxNrofSRS- |

TriggerStates-1),

| | |
|---|---|
| csi-RS | NZP-CSI-RS-ResourceId |

OPTIONAL, -- Cond NonCodebook

| | |
|---|---|
| slotOffset | INTEGER (1..32) |

```
OPTIONAL, -- Need S
  ...,
  [[
```

| | |
|---|---|
| aperiodicSRS-ResourceTriggerList | SEQUENCE |

(SIZE(1..maxNrofSRS-TriggerStates-2))

| | | |
|---|---|---|
| OF INTEGER (1..maxNrofSRS-TriggerStates-1) | OPTIONAL | -- Need M |

```
  ]]
  },
```

| | |
|---|---|
| semi-persistent | SEQUENCE { |
| associatedCSI-RS | NZP-CSI-RS-ResourceId |

```
OPTIONAL, -- Cond NonCodebook
  ...
  },
```

| | |
|---|---|
| periodic | SEQUENCE { |
| associatedCSI-RS | NZP-CSI-RS-ResourceId |

```
OPTIONAL, -- Cond NonCodebook
  ...
  }
  },
```

| | |
|---|---|
| usage | ENUMERATED |

{beamManagement, codebook, nonCodebook, antennaSwitching},

| | |
|---|---|
| alpha | Alpha |

OPTIONAL, -- Need S

| | |
|---|---|
| p0 | INTEGER (−202..24) |

OPTIONAL, -- Cond Setup

| | |
|---|---|
| pathlossReferenceRS | PathlossReferenceRS-Config |

OPTIONAL, -- Need M

| | |
|---|---|
| srs-PowerControlAdjustmentStates | ENUMERATED { sameAsFci2, |
| separateClosedLoop} | OPTIONAL, -- Need S |

```
  ...,
  [[
```

| | |
|---|---|
| pathlossReferenceRS-List-r16 | SEQUENCE |

```
(SIZE(1..maxNrofSRS-PathlossReferenceRS-r16-1)) OF PathlossReferenceRS-
Config
  OPTIONAL -- Need M
  ]]
  }
```

| | |
|---|---|
| PathlossReferenceRS-Config ::= | CHOICE { |
| ssb-Index | SSB-Index, |
| csi-RS-Index | NZP-CSI-RS-ResourceId |

}

| | |
|---|---|
| SRS-PosResourceSet-r16 ::= | SEQUENCE { |
| srs-PosResourceSetId-r16 | SRS-PosResourceSetId- |

r16,

| | |
|---|---|
| srs-PosResourceIdList-r16 | SEQUENCE |

(SIZE(1..maxNrofSRS-ResourcesPerSet)) OF SRS-PosResourceId-r16
OPTIONAL, -- Cond Setup

| | |
|---|---|
| resourceType-r16 | CHOICE { |
| aperiodic-r16 | SEQUENCE { |
| aperiodicSRS-ResourceTriggerList-r16 | SEQUENCE |

(SIZE(1..maxNrofSRS-TriggerStates-1))

| | |
|---|---|
| OF INTEGER (1..maxNrofSRS-TriggerStates-1) | OPTIONAL, -- Need M |
| slotOffset-r16 | INTEGER (1..32) |

```
OPTIONAL, -- Need S
  ...
  },
```

| | |
|---|---|
| semi-persistent-r16 | SEQUENCE { |

```
  ...
  },
```

| | |
|---|---|
| periodic-r16 | SEQUENCE { |

```
  ...
  }
  },
```

| | |
|---|---|
| alpha-r16 | Alpha |

OPTIONAL, -- Need S

| | |
|---|---|
| p0-r16 | INTEGER (−202..24) |

OPTIONAL, -- Cond Setup

| | |
|---|---|
| pathlossReferenceRS-Pos-r16 | CHOICE { |
| ssb-Index-16 | SSB-Index, |
| csi-RS-Index-r16 | NZP-CSI-RS-ResourceId, |
| ssb-r16 | SSB-InfoNcell-r16, |
| dl-PRS-r16 | DL-PRS-Info-r16 |

```
  }
OPTIONAL, -- Need M
  ...
  }
```

| | |
|---|---|
| SRS-TPC-CommandConfig ::= | SEQUENCE { |
| startingBitOfFormat2-3 | INTEGER (1..31) |

OPTIONAL, -- Need R

| | |
|---|---|
| fieldTypeFormat2-3 | INTEGER (0..1) |

```
OPTIONAL, -- Need R
  ...,
  [[
```

| | |
|---|---|
| startingBitOfFormat2-3SUL | INTEGER (1..31) |

```
OPTIONAL -- Need R
  ]]
  }
```

The UE may determine or calculate the SRS transmission power according to the above-described method and transmit the SRS based on the determined or calculated SRS transmission power.

Power Control of Random Access Channel

When the UE performs PRACH transmission in an active UL BWP (b) of a carrier (f) of a serving cell (c), the UE may determine PRACH transmission power P_{PRACH,b,f,c}(i) (dBm) on a PRACH transmission occasion (i) based on Equation 4 below.

P_{PRACH,b,f,c}(i)=min{P_{CMAX,f,c}(i),P_{PRACH,target,f,c}+PL_{b,f,c}} [Equation 4]

In Equation 4, P_{CMAX,f,c}(i) may denote configured UE transmission (or transmit) power. For example, the configured UE transmission (or transmit) power may be interpreted as ‘configured maximum UE output power’ defined in 3GPP TS 38.101-1 and/or TS 38.101-2. In addition, P_{RACH,target,f,c} denotes PRACH target reception power provided through higher layer signaling (e.g., RRC signaling, MAC-CE, etc.) for the active UL BWP. PL_{b,f,c} denotes PL for the active UL BWP, which may be determined based on a DL RS related to PRACH transmission in the active DL BWP of the serving cell (c). For example, the UE may determine PL related to PRACH transmission based on a synchronization signal/physical broadcast channel (SS/PBCH) block related to the PRACH transmission.

The above-described parameters and/or information for PRACH power control may be configured separately (independently) for each BWP. In this case, the corresponding parameters and/or information may be configured or indicated by higher layer signaling (RRC signaling, MAC-CE, etc.) and/or DCI. For example, the parameters and/or information for PRACH power control may be provided by RRC signaling such as RACH-ConfigGeneric, etc. The configuration of RACH-ConfigGeneric may be defined as following table 8, and a detailed definition of each parameter may be found in 3GPP TS Rel.16 38.331.

TABLE 8

| | |
|---|---|
| RACH-ConfigGeneric ::= | SEQUENCE { |
| prach-ConfigurationIndex | INTEGER (0..255), |

| | |
|---|---|
| msg1-FDM | ENUMERATED {one, two, four, eight}, |

| | |
|---|---|
| msg1-FrequencyStart | INTEGER (0..maxNrofPhysicalResourceBlocks- |

1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, n7, n8, n10, n20, |

n50, n100, n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, |

```
sl40, sl80},
    ...,
    [[
```

| | |
|---|---|
| ra-ResponseWindow-r16 | ENUMERATED {sl1, sl2, sl4, sl8, sl10, sl20, sl40, |

sl60, sl80, sl160} OPTIONAL, -- Need R

| | |
|---|---|
| prach-ConfigurationIndex-v16xy | INTEGER (256..262) |

```
OPTIONAL -- Need R
    ]]
  }
```

The UE may determine or calculate the PRACH transmission power according to the above-described method and transmit the PRACH based on the determined or calculated PRACH transmission power.

Priorities for Transmission Power Control

Hereinafter, a method of controlling the transmission power of a UE will be described in consideration of single cell operation in a carrier aggregation environment or single cell operation in multi-UL carrier (e.g., two carriers) environment.

In this case, if the total UE transmission (or transmit) power of UL transmissions (e.g., PUSCH, PUCCH, SRS, and PRACH transmissions described above in (1) to (4)) on transmission occasions (i) exceeds the linear value of configured UE transmission (or transmit) power (e.g., \hat{P}_{CMAX}(i)), the UE may be configured to allocate UL transmission power according to priorities (priority order). For example, the configured UE transmission (or transmit) power may mean ‘configured maximum UE output power’ (e.g., P_{CMAX}(i)) defined in 3GPP TS 38.101-1 and/or TS 38.101-2.

In this case, the priorities for transmission power control may be configured or defined in the following order.
PRACH transmission on Primary Cell (PCell)
PUCCH for hybrid automatic repeat and request-acknowledgement (HARQ-ACK) information and/or scheduling request (SR) or PUSCH for HARQ-ACK information
PUCCH or PUSCH for channel state information (CSI)
PUSCH for neither HARQ-ACK information nor CSI
SRS transmission or PRACH transmission in serving cell other than PCell (however, an aperiodic SRS has a higher priority than a semi-persistent SRS and/or periodic SRS)

The UE may control the total transmission power to be less than or equal to the linear value of the configured UE transmission (or transmit) power in each symbol of the transmission occasion (i) based on the power allocation according to the priority order as described above. For example, to this end, the UE may be configured to scale and/or drop the power of UL transmission with a low priority. In this case, details of scaling and/or dropping may be configured or defined according to UE implementation.

As a particular example, for transmissions with the same priority in carrier aggregation, the UE may assume that transmission in a Pcell has a higher priority than transmission in a secondary cell (Scell). Additionally/alternatively, for transmissions with the same priority in multiple UL carriers (e.g., two UL carriers), the UE may assume a carrier on which PUCCH transmission is configured to have a high priority. In addition, if PUCCH transmission is not configured on any carriers, the UE may assume that transmission on a non-supplementary UL carrier has a high priority.

Transmission Power Control Procedure

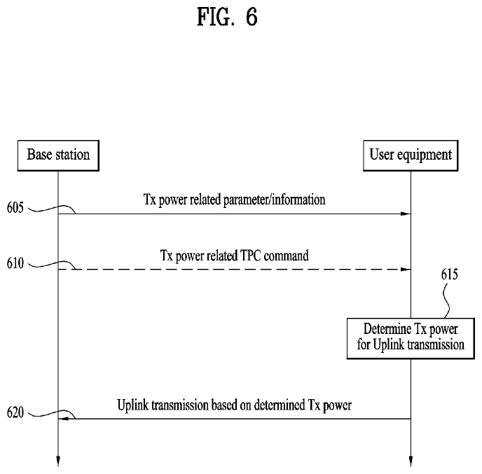

FIG. 6 is a diagram illustrating an exemplary procedure for controlling UL transmission power to which various embodiments are applicable.

First, a UE may receive parameters and/or information related to transmission power (Tx power) from a BS (605). In this case, the UE may receive the corresponding parameters and/or information through higher layer signaling (e.g., RRC signaling, MAC-CE, etc.). For example, for PUSCH transmission, PUCCH transmission, SRS transmission, and/or PRACH transmission, the UE may receive the above-described parameters and/or information related to transmission power control.

The UE may receive a TPC command related to transmission power from the BS (1010). In this case, the UE may receive the corresponding TPC command through lower layer signaling (e.g., DCI). For example, for PUSCH transmission, PUCCH transmission, and/or SRS transmission, the UE may receive information on a TPC command to be used for determining a power control adjustment state, etc. in a TPC command field of a predefined DCI format as described above. However, the corresponding step may be omitted in PRACH transmission.

The UE may determine (or calculate) transmission power for UL transmission based on the parameters, information, and/or TPC command received from the BS (615). For example, the UE may determine PUSCH transmission power, PUCCH transmission power, SRS transmission power, and/or PRACH transmission power according to the above-described methods (e.g., Equations 1 to 4, etc.). Additionally/alternatively, when two or more UL channels and/or signals need to be transmitted together as in carrier aggregation, the UE may determine the transmission power for UL transmission in consideration of the above-described priorities.

The UE may perform transmission of one or more UL channels and/or signals (e.g., PUSCH, PUCCH, SRS, PRACH, etc.) to the BS based on the determined (or calculated) transmission power (620).

1.5. QCL (Quasi Co-Located or Quasi Co-Location)

In order for the UE to decode a PDSCH based on a detected PDCCH with DCI intended for the corresponding UE and a given serving cell, a list of up to M TCI-state configurations may be configured by the higher layer parameter PDSCH-Config, where M depends on UE capability.

Each TCI-state includes parameters for establishing a QCL relationship between one or two DL RSs and DMRS ports of the PDSCH. The QCL relationship is configured by the higher layer parameter qcl-Type1 for a first DL RS and the higher layer parameter qcl-Type2 for a second DL RS (if configured).

The QCL type of each DL RS is given by a parameter ‘qcl-Type’ in QCL-Info and have one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if the target antenna port is a specific non-zero power (NZP) CSI-RS, corresponding NZP CSI-RS antenna ports may be indicated/configured to be QCL with a specific tracking reference signal (TRS) in terms of QCL-Type A and QCL with a specific SSB in terms of QCL-Type D. Upon receiving the above indication/configuration, the UE may receive the corresponding NZP CSI-RS based on Doppler and delay values measured on the QCL-TypeA TRS and apply a reception beam used to receive the QCL-TypeD SSB to the reception of the corresponding NZP CSI-RS.

1.6. Beam Management (BM)

BM is a series of processes for acquiring and maintaining a set of BS (or transmission and reception point (TRP)) beams and/or UE beams available for DL and UL transmissions/receptions. BM may include the following processes and terminology.
Beam measurement: The BS or the UE measures the characteristics of a received beamformed signal.
Beam determination: The BS or the UE selects its Tx beam/reception (Rx) beam.
Beam sweeping: A spatial domain is covered by using Tx beams and/or Rx beams in a predetermined manner during a predetermined time interval.
Beam report: The UE reports information about a beamformed signal based on a beam measurement.

The BM process may be divided into (1) a DL BM process using an SSB or a CSI-RS and (2) a UL BM process using a sounding reference signal (SRS). Further, each BM process may include Tx beam sweeping for determining a Tx beam and Rx beam sweeping for determining an Rx beam.

DL BM-Related Beam Indication

The UE may receive at least a list of up to M candidate transmission configuration indication (TCI) states for QCL indication by RRC signaling. M depends on a UE capability and may be 64.

Each TCI state may be configured with one RS set. Table 9 describes an example of a TCI-State IE. The TC-State IE is related to a QCL type corresponding to one or two DL RSs.

TABLE 9
TCI-State
The IE TCI-State associates one or two DL reference signals
with a corresponding quasi-colocation (QCL) type.
TCI-State information element

-- ASN1START
-- TAG-TCI-STATE-START

| TCI-State ::= | SEQUENCE { | |
|---|---|---|
| tci-StateId | | TCI-StateId, |
| qcl-Type1 | | QCL-Info, |
| qcl-Type2 | | QCL-Info |
| | OPTIONAL, | -- Need R |

...
}

| QCL-Info ::= | SEQUENCE { | |
|---|---|---|
| cell | | ServCellIndex |
| | OPTIONAL, | -- Need R |

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |
| | typeD}, |

...
}
-- TAG-TCI-STATE-STOP
-- ASN1STOP

In Table 9, ‘bwp-Id’ identifies a DL BWP in which an RS is located, ‘cell’ indicates a carrier in which the RS is located, and ‘referencesignal’ indicates reference antenna port(s) serving as a QCL source for target antenna port(s) or an RS including the reference antenna port(s). The target antenna port(s) may be for a CSI-RS, PDCCH DMRS, or PDSCH DMRS.

UL BM Process

In UL BM, reciprocity (or beam correspondence) between a Tx beam and an Rx beam may or may not be established depending on UE implementation. When the Tx beam-Rx beam reciprocity is established in both a BS and a UE, a UL beam pair may be obtained based on a DL beam pair. However, when the Tx beam-Rx beam reciprocity is not established in at least one of the BS or the UE, a process of determining a UL beam pair is necessary separately from DL beam pair determination.

Even when both the BS and the UE maintain the beam correspondence, the BS may use the UL BM process for determining a DL Tx beam, even though the UE does not request a report of a (preferred) beam

UM BM may be performed by beamformed UL SRS transmission, and whether to apply UL BM to an SRS resource set is configured by (an RRC parameter) usage. When usage is set to ‘BeamManagement (BM)’, only one SRS resource in each of a plurality of SRS resource sets may be transmitted in a given time instant.

The UE may be configured with one or more sounding reference signal (SRS) resource sets configured by (an RRC layer parameter) SRS-ResourceSet (by RRC signaling). For each SRS resource set, the UE may be configured with K≥1 SRS resources, where K is a natural number and a maximum value of K is indicated by SRS_capability.

The UL BM process may be divided into a UE's Tx beam sweeping and a BS's Rx beam sweeping.

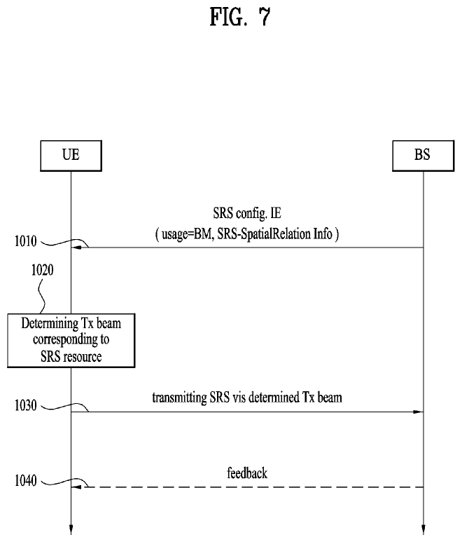

FIG. 7 is a diagram illustrating a signal flow for an exemplary UL BM process using an SRS, which is applicable to various embodiments.
A UE receives, from a BS, RRC signaling (e.g., SRS-Config IE) including (an RRC parameter) usage set to ‘beam management’ (1010). The SRS-Config IE is used for an SRS transmission configuration. The SRS-Config IE includes an SRS-Resources list and an SRS-ResourceSet list. Each SRS resource set refers to a set of SRS-resources.
The UE determines Tx beamforming for SRS resources to be transmitted based on SRS-SpatialRelation Info included in the SRS-Config IE (1020). SRS-SpatialRelation Info is configured for each SRS resource and indicates whether to apply the same beamforming as used for an SSB, a CSI-RS, or an SRS on an SRS resource basis.
If SRS-SpatialRelationInfo is configured for an SRS resource, the same beamforming as used for the SSB, the CSI-RS, or the SRS is applied for transmission. However, if SRS-SpatialRelationInfo is not configured for the SRS resource, the UE randomly determines Tx beamforming and transmits the SRS by the determined Tx beamforming (1030).

More specifically, for a P-SRS with ‘SRS-ResourceConfigType’ set to ‘periodic’:

i) if SRS-SpatialRelationInfo is set to ‘SSB/PBCH,’ the UE transmits the corresponding SRS by applying the same spatial domain transmission filter as the spatial domain Rx filter used for reception of the SSB/PBCH (or a spatial domain transmission filter generated from the corresponding filter); or

ii) if SRS-SpatialRelationInfo is set to ‘CSI-RS,’ the UE transmits the SRS by applying the same spatial domain transmission filter used for reception of the CSI-RS; or

iii) if SRS-SpatialRelationInfo is set to ‘SRS,’ the UE transmits the SRS by applying the same spatial domain transmission filter used for transmission of the SRS.
Additionally, the UE may receive or may not receive a feedback for the SRS from the BS, as in the following three cases (1040).

i) If Spatial_Relation_Info is configured for all SRS resources within an SRS resource set, the UE transmits the SRS with a beam indicated by the BS. For example, if the Spatial_Relation_Info indicates all the same SSB, CRI, or SRI, the UE repeatedly transmits the SRS with the same beam.

ii) Spatial_Relation_Info may be configured for none of the SRS resources within the SRS resource set. In this case, the UE may perform transmission while freely changing SRS beamforming.

iii) Spatial_Relation_Info may be configured for only some SRS resources within the SRS resource set. In this case, the UE may transmit the SRS in the configured SRS resources with the indicated beam, and transmit the SRS in SRS resources for which Spatial_Relation_Info is not configured, by randomly applying Tx beamforming.

1.7. UL-DL Timing Relationship

Timing advance maintenance on UL will now be described.

In a system based on OFDM technology, a time required for a signal transmitted by a UE to reach a BS may vary depending on the radius of a cell, the location of the UE within the cell, and/or the moving speed of the UE. That is, if the BS does not separately manage transmission signal timings of respective UEs, there is a possibility that a transmission signal of a UE may interfere with signals transmitted by other UEs, and thus an error rate of signals received by the BS increases.

More specifically, a time consumed for a signal transmitted by a UE attempting to perform transmission at a cell edge to arrive at the BS will be longer than a time required for a signal transmitted by a UE at the center of the cell to arrive at the BS. Conversely, a time required for a signal transmitted by the UE located at the center of the cell to arrive at the BS will be relatively shorter than that of the UE located at the edge of the cell.

Since data or signals that all UEs in the cell transmit should be received within every valid time boundary in order to prevent interference in terms of the BS, the BS needs to appropriately adjust transmission timings of the signals transmitted by the UEs according to situations of the UEs and this adjustment is referred to as timing advance management.

One method of managing a timing advance may be a random access operation. That is, the random access operation causes the BS to receive a random access preamble transmitted by the UE. The BS calculates a timing advance value to make a transmission timing of the UE faster or slower using information about the received random access preamble. Then, the BS informs the UE of the calculated timing advance value through a random access response. The UE updates a UL transmission timing using the timing advance value.

As another method, the BS receives a sounding reference signal (SRS) periodically or randomly transmitted by the UE and calculates the timing advance value for the UE through the received signal. The BS informs the UE of the timing advance value and then the UE updates a transmission timing thereof.

As described above, the BS measures the transmission timing of the UE through the random access preamble or the SRS, calculates a timing value to be corrected, and informs the UE of the timing value to be corrected. The timing advance value (i.e., timing value to be corrected) transmitted by the BS to the UE is referred to as a timing advance command (TAC). The TAC is processed in a MAC layer. Since the UE is not always located at a fixed position, the transmission timing of the UE is changed at every time according to the moving speed of the UE and the location of the UE.

In this regard, upon receiving the TAC once from the BS, the UE needs to assume that the TAC is not always valid for an infinite time but the TAC is valid only for a specific time. A timing advance timer (TAT) is used for this purpose. That is, upon receiving the TAC from the BS, the UE starts the TAT. The UE assumes that a UL timing thereof is synchronized with the BS when the TAT is in operation. The value of the TAT may be transmitted through an RRC signal such as system information or radio bearer reconfiguration. Upon receiving a new TAC from the BS while the TAT is in operation, the UE restarts the TAT. When the TAT expires or the TAT does not operate, the UE does not transmit any UL signals, such as PUSCH and PUCCH signals, except for the random access preamble, under the assumption that the UL timing of the UE is not synchronized with the BS.

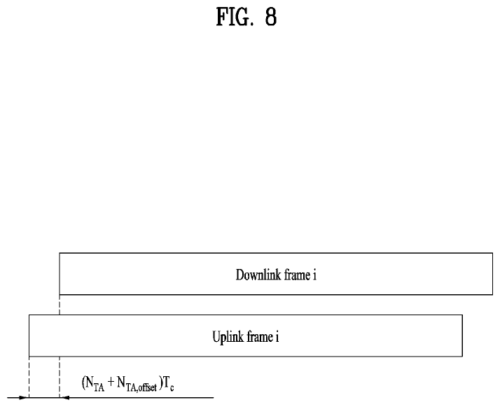

FIG. 8 is a diagram illustrating an exemplary UL-DL timing relationship applicable to various embodiments.

Referring to FIG. 8, a UE starts to transmit UL frame i T_{TA}(=(N_{TA}+N_{TA,offset})T_{c}) seconds before a DL radio frame corresponding to UL frame i. However, T_{TA}=0 exceptionally for a msgA transmission on a PUSCH. T_{c}=0.509 ns.

The UE may be provided with a value N_{TA,offset} of a timing advance (TA) offset for a serving cell by n-TimingAdvanceOffset for the serving cell. When the UE is not provided with n-TimingAdvanceOffset for the serving cell, the UE may determine a default value N_{TA,offset} of the TA offset for the serving cell.

In the case of a random access response, a TA command, T_{A} for a timing advance group (TAG) indicates N_{TA} values by index values of T_{A}=0, 1, 2, . . . , 3846, where an amount of the time alignment for a TAG with an SCS of 2^{μ}*15 kHz is N_{TA} (=T_{A}*16*64/2^{μ}). N_{TA} is relative to the SCS of a first UL transmission from the UE after reception of a random access response.

In other cases, a TA command, T_{A} for a TAG indicates adjustment of a current N_{TA} value, N_{TA_old} to a new N_{TA} value, N_{TA_new} by index values of T_{A} (=0, 1, 2, . . . , 63), where for a SCS of 2^{μ}*15 kHz, N_{TA_new}=N_{TA_old} (T_{A}−31)*16*64/2^{μ}.

2. Positioning

Positioning may refer to determining the geographical position and/or velocity of the UE based on measurement of radio signals. Location information may be requested by and reported to a client (e.g., an application) associated with to the UE. The location information may also be requested by a client within or connected to a core network. The location information may be reported in standard formats such as formats for cell-based or geographical coordinates, together with estimated errors of the position and velocity of the UE and/or a positioning method used for positioning.

2.1. Positioning Protocol Configuration

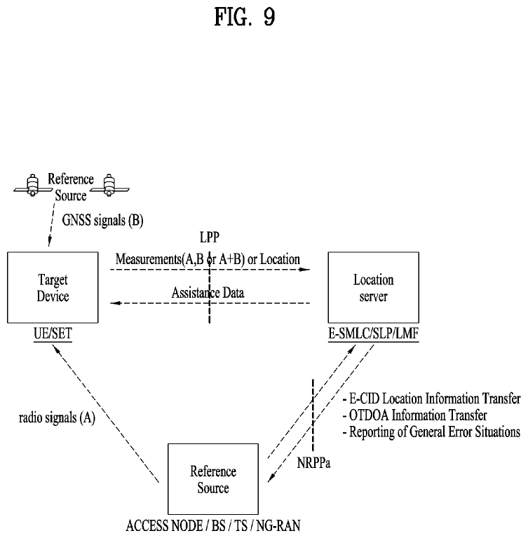

FIG. 9 is a diagram illustrating an exemplary positioning protocol configuration for positioning a UE, to which various embodiments are applicable.

Referring to FIG. 9, an LTE positioning protocol (LPP) may be used as a point-to-point protocol between a location server (E-SMLC and/or SLP and/or LMF) and a target device (UE and/or SET), for positioning the target device using position-related measurements obtained from one or more reference resources. The target device and the location server may exchange measurements and/or location information based on signal A and/or signal B over the LPP.

NRPPa may be used for information exchange between a reference source (access node and/or BS and/or TP and/or NG-RAN node) and the location server.

The NRPPa protocol may provide the following functions.
E-CID Location Information Transfer. This function allows the reference source to exchange location information with the LMF for the purpose of E-CID positioning.
OTDOA Information Transfer. This function allows the reference source to exchange information with the LMF for the purpose of OTDOA positioning.
Reporting of General Error Situations. This function allows reporting of general error situations, for which function-specific error messages have not been defined.

2.2. PRS (Positioning Reference Signal)

For such positioning, a positioning reference signal (PRS) may be used. The PRS is a reference signal used to estimate the position of the UE.

A positioning frequency layer may include one or more PRS resource sets, each including one or more PRS resources.

Sequence Generation

A PRS sequence r(m) (m=0, 1, . . . ) may be defined by Equation 5.

$$r ( m ) = \frac{1}{\sqrt{2}} ( 1 - 2 c ( m ) ) + j \frac{1}{\sqrt{2}} ( 1 - 2 c ( m + 1 ) ) \qquad [ Equation 5 ]$$

In Equation 1, c(i) may be a pseudo-random sequence. A pseudo-random sequence generator may be initialized by Equation 6.

$${c}_{init} = ( {2}^{22} ⌊ \frac{{n}_{ID , seq}^{PRS}}{1024} ⌋ + {2}^{10} ( {N}_{symb}^{slot} {n}_{s , f}^{μ} + l + 1 ) ( 2 ( {n}_{ID , seq}^{PRS} mod 1024 ) + 1 ) + ( {n}_{ID , seq}^{PRS} mod 1024 ) ) mod {2}^{31} \qquad [ Equation 6 ]$$

In Equation 2, n_{s,f}^{μ} may be a slot number in a frame in an SCS configuration μ. A DL PRS sequence ID n_{ID,seq}^{PRS}ϵ{0,1, . . . ,4095} may be given by a higher-layer parameter (e.g., DL-PRS-SequenceId). l may be an OFDM symbol in a slot to which the sequence is mapped.

Mapping to Physical Resources in a DL PRS Resource

A PRS sequence r(m) may be scaled by β_{PRS} and mapped to REs (k,l)_{p,μ}, specifically by Equation 7. (k,l)_{p,μ} may represent an RE (k, l) for an antenna port p and the SCS configuration μ.

α_{k,l}^{(p,μ)}=β_{PRS}r(m)
m=0, 1, . . .
k=mK_{comb}^{PRS}+((k_{offset}^{PRS}+k′) mod K_{comb}^{PRS)}
l=lₛₜₐᵣₜ^{PRS},lₛₜₐᵣₜ^{PRS}+1, . . . ,lₛₜₐᵣₜ^{PRS}+L_{PRS}−1

Herein, the following conditions may have to be satisfied:
The REs (k,l)_{p,μ} are included in an RB occupied by a DL PRS resource configured for the UE;
The symbol l not used by any SS/PBCH block used by a serving cell for a DL PRS transmitted from the serving cell or indicated by a higher-layer parameter SSB-positionlnBurst for a DL PRS transmitted from a non-serving cell;
A slot number satisfies the following PRS resource set-related condition;

lₛₜₐᵣₜ^{PRS} is the first symbol of the DL PRS in the slot, which may be given by a higher-layer parameter DL-PRS-ResourceSymbolOffset. The time-domain size of the DL PRS resource, L_{PRS}ϵ{2,4,6,12} may be given by a higher-layer parameter DL-PRS-NumSymbols. A comb size K_{comb}^{PRS}ϵ{2, 4, 6,12} may be given by a higher-layer parameter transmissionComb. A combination {L_{PRS},K_{comb}^{PRS}} of L_{PRS} and K_{comb}^{PRS} may be one of {2, 2}, {4, 2}, {6, 2}, {12, 2}, {4, 4}, {12, 4}, {6, 6}, {12, 6} and/or {12, 12}. An RE offset k_{offset}^{PRS}ϵ{0,1, . . . , K_{comb}^{PRS}−1} may be given by combOffset. A frequency offset k′ may be a function of l−lₛₜₐᵣₜ^{PRS} as shown in Table 10.

TABLE 10

| | Symbol number within the downlink PRS resource l − lₛₜₐᵣₜ^{PRS} | | | | | | | | | | | |
|---|---|---|---|---|---|---|---|---|---|---|---|---|
| K_{comb}^{PRS} | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |

A reference point for k=0 may be the position of point A in a positioning frequency layer in which the DL PRS resource is configured. Point A may be given by a higher-layer parameter dl-PRS-PointA-r16.

Mapping to Slots in a DL PRS Resource Set

A DL PRS resource included in a DL PRS resource set may be transmitted in a slot and a frame which satisfy the following Equation 8.

$$( {N}_{slot}^{frame , μ} {n}_{f} + {n}_{s , f}^{μ} - {T}_{offset}^{PRS} - {T}_{offset , res}^{PRS} ) mod {2}^{μ} {T}_{per}^{PRS} ∈ {\{ {iT}_{gap}^{PRS} \}}_{i = 0}^{{T}_{rep}^{PRS} - 1} \qquad [ Equation 8 ]$$

Nₛₗₒₜ^{frame,μ} may be the number of slots per frame in the SCS configuration μ. n_{f} may be a system frame number (SFN). n_{s,f}^{μ} may be a slot number in a frame in the SCS configuration μ. A slot offset T_{offset}^{PRS}ϵ{0,1, . . . ,Tₚₑᵣ^{RPS}−1} may be given by a higher-layer parameter DL-PRS-ResourceSetSlotOffset. A DL PRS resource slot offset T_{offset,res}^{PRS} may be given by a higher layer parameter DL-PRS-ResourceSlotOffset. A periodicity

Tₚₑᵣ^{PRS}ϵ{4, 5, 8, 10, 16, 20, 32, 40, 64, 80, 160, 320, 640, 1280, 2560, 5120, 10240} may be given by a higher-layer parameter DL-PRS-Periodicity. A repetition factor Tᵣₑₚ^{PRS}ϵ{1,2,4,6,8,16,32} may be given by a higher-layer parameter DL-PRS-ResourceRepetitionFactor. A muting repetition factor T_{muting}^{PRS} may be given by a higher-layer parameter DL-PRS-MutingBitRepetitionFactor. A time gap T_{gap}^{PRS}ϵ{1,2,4,8,16,32} may be given by a higher-layer parameter DL-PRS-ResourceTimeGap.

2.3. UE Positioning Architecture

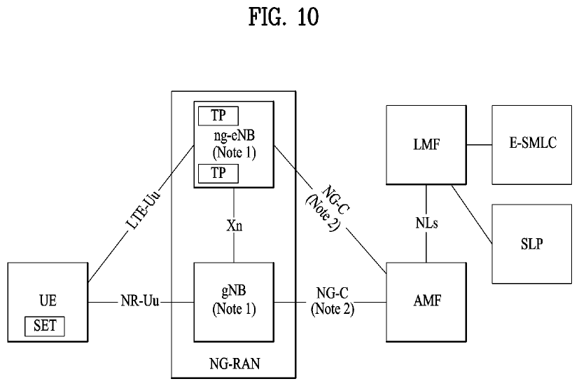

FIG. 10 illustrates an exemplary system architecture for measuring positioning of a UE to which various embodiments are applicable.

Referring to FIG. 10, an AMF may receive a request for a location service associated with a particular target UE from another entity such as a gateway mobile location center (GMLC) or the AMF itself decides to initiate the location service on behalf of the particular target UE. Then, the AMF transmits a request for a location service to a location management function (LMF). Upon receiving the request for the location service, the LMF may process the request for the location service and then returns the processing result including the estimated position of the UE to the AMF. In the case of a location service requested by an entity such as the GMLC other than the AMF, the AMF may transmit the processing result received from the LMF to this entity.

A new generation evolved-NB (ng-eNB) and a gNB are network elements of the NG-RAN capable of providing a measurement result for positioning. The ng-eNB and the gNB may measure radio signals for a target UE and transmits a measurement result value to the LMF. The ng-eNB may control several TPs, such as remote radio heads, or PRS-only TPs for support of a PRS-based beacon system for E-UTRA.

The LMF is connected to an enhanced serving mobile location center (E-SMLC) which may enable the LMF to access the E-UTRAN. For example, the E-SMLC may enable the LMF to support OTDOA, which is one of positioning methods of the E-UTRAN, using DL measurement obtained by a target UE through signals transmitted by eNBs and/or PRS-only TPs in the E-UTRAN.

The LMF may be connected to an SUPL location platform (SLP). The LMF may support and manage different location services for target UEs. The LMF may interact with a serving ng-eNB or a serving gNB for a target UE in order to obtain position measurement for the UE. For positioning of the target UE, the LMF may determine positioning methods, based on a location service (LCS) client type, required quality of service (QoS), UE positioning capabilities, gNB positioning capabilities, and ng-eNB positioning capabilities, and then apply these positioning methods to the serving gNB and/or serving ng-eNB. The LMF may determine additional information such as accuracy of the location estimate and velocity of the target UE. The SLP is a secure user plane location (SUPL) entity responsible for positioning over a user plane.

The UE may measure the position thereof using DL RSs transmitted by the NG-RAN and the E-UTRAN. The DL RSs transmitted by the NG-RAN and the E-UTRAN to the UE may include a SS/PBCH block, a CSI-RS, and/or a PRS. Which DL RS is used to measure the position of the UE may conform to configuration of LMF/E-SMLC/ng-eNB/E-UTRAN etc. The position of the UE may be measured by an RAT-independent scheme using different global navigation satellite systems (GNSSs), terrestrial beacon systems (TBSs), WLAN access points, Bluetooth beacons, and sensors (e.g., barometric sensors) installed in the UE. The UE may also contain LCS applications or access an LCS application through communication with a network accessed thereby or through another application contained therein. The LCS application may include measurement and calculation functions needed to determine the position of the UE. For example, the UE may contain an independent positioning function such as a global positioning system (GPS) and report the position thereof, independent of NG-RAN transmission. Such independently obtained positioning information may be used as assistance information of positioning information obtained from the network.

2.4. Operation for UE Positioning

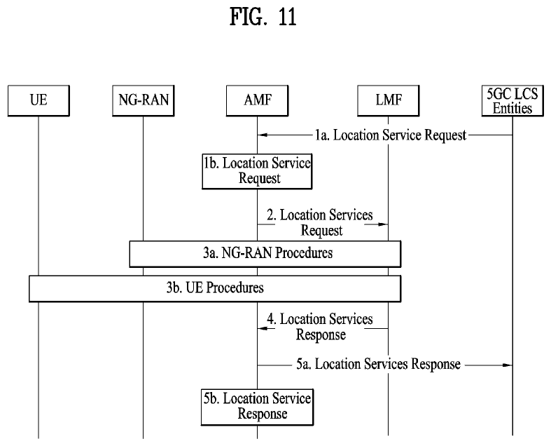

FIG. 11 illustrates an implementation example of a network for UE positioning.

When an AMF receives a request for a location service in the case in which the UE is in connection management (CM)-IDLE state, the AMF may make a request for a network triggered service in order to establish a signaling connection with the UE and to assign a specific serving gNB or ng-eNB. This operation procedure is omitted in FIG. 9. In other words, in FIG. 11 it may be assumed that the UE is in a connected mode. However, the signaling connection may be released by an NG-RAN as a result of signaling and data inactivity while a positioning procedure is still ongoing.

An operation procedure of the network for UE positioning will now be described in detail with reference to FIG. 11. In step 1a, a 5GC entity such as GMLC may transmit a request for a location service for measuring the position of a target UE to a serving AMF. Here, even when the GMLC does not make the request for the location service, the serving AMF may determine the need for the location service for measuring the position of the target UE according to step 1b. For example, the serving AMF may determine that itself will perform the location service in order to measure the position of the UE for an emergency call.

In step 2, the AMF transfers the request for the location service to an LMF. In step 3a, the LMF may initiate location procedures with a serving ng-eNB or a serving gNB to obtain location measurement data or location measurement assistance data. For example, the LMF may transmit a request for location related information associated with one or more UEs to the NG-RAN and indicate the type of necessary location information and associated QoS. Then, the NG-RAN may transfer the location related information to the LMF in response to the request. In this case, when a location determination method according to the request is an enhanced cell ID (E-CID) scheme, the NG-RAN may transfer additional location related information to the LMF in one or more NR positioning protocol A (NRPPa) messages. Here, the “location related information” may mean all values used for location calculation such as actual location estimate information and radio measurement or location measurement. Protocol used in step 3a may be an NRPPa protocol which will be described later.

Additionally, in step 3b, the LMF may initiate a location procedure for DL positioning together with the UE. For example, the LMF may transmit the location assistance data to the UE or obtain a location estimate or location measurement value. For example, in step 3b, a capability information transfer procedure may be performed. Specifically, the LMF may transmit a request for capability information to the UE and the UE may transmit the capability information to the LMF. Here, the capability information may include information about a positioning method supportable by the LFM or the UE, information about various aspects of a particular positioning method, such as various types of assistance data for an A-GNSS, and information about common features not specific to any one positioning method, such as ability to handle multiple LPP transactions. In some cases, the UE may provide the capability information to the LMF although the LMF does not transmit a request for the capability information.

As another example, in step 3b, a location assistance data transfer procedure may be performed. Specifically, the UE may transmit a request for the location assistance data to the LMF and indicate particular location assistance data needed to the LMF. Then, the LMF may transfer corresponding location assistance data to the UE and transfer additional assistance data to the UE in one or more additional LTE positioning protocol (LPP) messages. The location assistance data delivered from the LMF to the UE may be transmitted in a unicast manner. In some cases, the LMF may transfer the location assistance data and/or the additional assistance data to the UE without receiving a request for the assistance data from the UE.

As another example, in step 3b, a location information transfer procedure may be performed. Specifically, the LMF may send a request for the location (related) information associated with the UE to the UE and indicate the type of necessary location information and associated QoS. In response to the request, the UE may transfer the location related information to the LMF. Additionally, the UE may transfer additional location related information to the LMF in one or more LPP messages. Here, the “location related information” may mean all values used for location calculation such as actual location estimate information and radio measurement or location measurement. Typically, the location related information may be a reference signal time difference (RSTD) value measured by the UE based on DL RSs transmitted to the UE by a plurality of NG-RANs and/or E-UTRANs. Similarly to the above description, the UE may transfer the location related information to the LMF without receiving a request from the LMF.

The procedures implemented in step 3b may be performed independently but may be performed consecutively. Generally, although step 3b is performed in order of the capability information transfer procedure, the location assistance data transfer procedure, and the location information transfer procedure, step 3b is not limited to such order. In other words, step 3b is not required to occur in specific order in order to improve flexibility in positioning. For example, the UE may request the location assistance data at any time in order to perform a previous request for location measurement made by the LMF. The LMF may also request location information, such as a location measurement value or a location estimate value, at any time, in the case in which location information transmitted by the UE does not satisfy required QoS. Similarly, when the UE does not perform measurement for location estimation, the UE may transmit the capability information to the LMF at any time.

In step 3b, when information or requests exchanged between the LMF and the UE are erroneous, an error message may be transmitted and received and an abort message for aborting positioning may be transmitted and received.

Protocol used in step 3b may be an LPP protocol which will be described later.

Step 3b may be performed additionally after step 3a but may be performed instead of step 3a.

In step 4, the LMF may provide a location service response to the AMF. The location service response may include information as to whether UE positioning is successful and include a location estimate value of the UE. If the procedure of FIG. 9 has been initiated by step 1a, the AMF may transfer the location service response to a 5GC entity such as a GMLC. If the procedure of FIG. 11 has been initiated by step 1b, the AMF may use the location service response in order to provide a location service related to an emergency call.

2.5. Positioning Protocol

LTE Positioning Protocol (LPP)

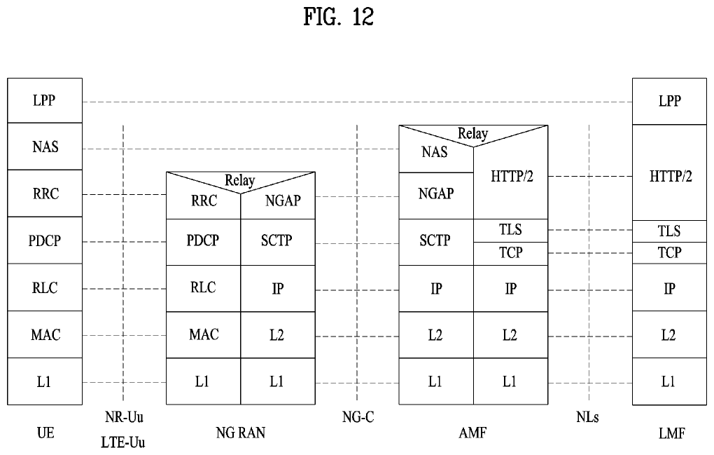

FIG. 12 illustrates an exemplary protocol layer used to support LPP message transfer between an LMF and a UE. An LPP protocol data unit (PDU) may be carried in a NAS PDU between an AMF and the UE.

Referring to FIG. 12, LPP is terminated between a target device (e.g., a UE in a control plane or an SUPL enabled terminal (SET) in a user plane) and a location server (e.g., an LMF in the control plane or an SLP in the user plane). LPP messages may be carried as transparent PDUs cross intermediate network interfaces using appropriate protocols, such an NGAP over an NG-C interface and NAS/RRC over LTE-Uu and NR-Uu interfaces. LPP is intended to enable positioning for NR and LTE using various positioning methods.

For example, a target device and a location server may exchange, through LPP, capability information therebetween, assistance data for positioning, and/or location information. The target device and the location server may exchange error information and/or indicate abort of an LPP procedure, through an LPP message.

NR Positioning Protocol A (NRPPa)

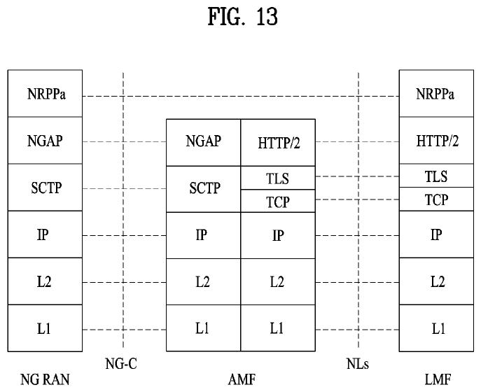

FIG. 13 illustrates an exemplary protocol layer used to support NRPPa PDU transfer between an LMF and an NG-RAN node.

NRPPa may be used to carry information between an NG-RAN node and an LMF. Specifically, NRPPa may carry an E-CID for measurement transferred from an ng-eNB to an LMF, data for support of an OTDOA positioning method, and a cell-ID and a cell position ID for support of an NR cell ID positioning method. An AMF may route NRPPa PDUs based on a routing ID of an involved LMF over an NG-C interface without information about related NRPPa transaction.

An NRPPa procedure for location and data collection may be divided into two types. The first type is a UE associated procedure for transfer of information about a particular UE (e.g., location measurement information) and the second type is a non-UE-associated procedure for transfer of information applicable to an NG-RAN node and associated TPs (e.g., gNB/ng-eNB/TP timing information). The two types may be supported independently or may be supported simultaneously.

2.6. Positioning Measurement Method

Positioning methods supported in the NG-RAN may include a GNSS, an OTDOA, an E-CID, barometric sensor positioning, WLAN positioning, Bluetooth positioning, a TBS, uplink time difference of arrival (UTDOA) etc. Although any one of the positioning methods may be used for UE positioning, two or more positioning methods may be used for UE positioning.

OTDOA (Observed Time Difference of Arrival)

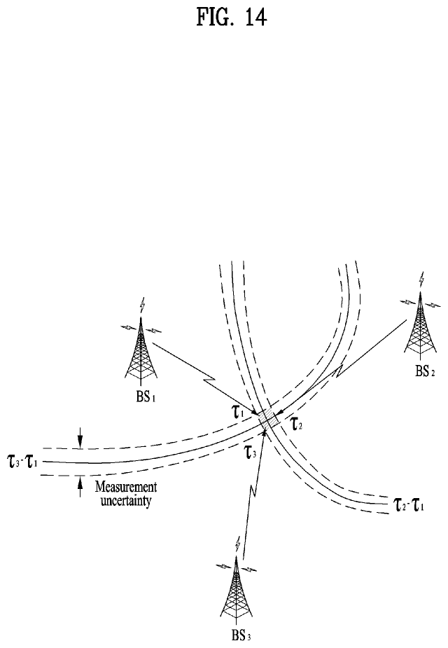

FIG. 14 is a diagram illustrating an observed time difference of arrival (OTDOA) positioning method, to which various embodiments are applicable;

The OTDOA positioning method uses time measured for DL signals received from multiple TPs including an eNB, an ng-eNB, and a PRS-only TP by the UE. The UE measures time of received DL signals using location assistance data received from a location server. The position of the UE may be determined based on such a measurement result and geographical coordinates of neighboring TPs.

The UE connected to the gNB may request measurement gaps to perform OTDOA measurement from a TP. If the UE is not aware of an SFN of at least one TP in OTDOA assistance data, the UE may use autonomous gaps to obtain an SFN of an OTDOA reference cell prior to requesting measurement gaps for performing reference signal time difference (RSTD) measurement.

Here, the RSTD may be defined as the smallest relative time difference between two subframe boundaries received from a reference cell and a measurement cell. That is, the RSTD may be calculated as the relative time difference between the start time of a subframe received from the measurement cell and the start time of a subframe from the reference cell that is closest to the subframe received from the measurement cell. The reference cell may be selected by the UE.

For accurate OTDOA measurement, it is necessary to measure time of arrival (ToA) of signals received from geographically distributed three or more TPs or BSs. For example, ToA for each of TP 1, TP 2, and TP 3 may be measured, and RSTD for TP 1 and TP 2, RSTD for TP 2 and TP 3, and RSTD for TP 3 and TP 1 are calculated based on three ToA values. A geometric hyperbola is determined based on the calculated RSTD values and a point at which curves of the hyperbola cross may be estimated as the position of the UE. In this case, accuracy and/or uncertainty for each ToA measurement may occur and the estimated position of the UE may be known as a specific range according to measurement uncertainty.

For example, RSTD for two TPs may be calculated based on Equation 9 below.

$$RSTDi {,}_{1} = \frac{\sqrt{{( {x}_{t} - {x}_{i} )}^{2} + {( {y}_{t} - {y}_{i} )}^{2}}}{c} - \frac{\sqrt{{( {x}_{t} - {x}_{1} )}^{2} + {( {y}_{t} - {y}_{1} )}^{2}}}{c} + ( {T}_{i} - {T}_{1} ) + ( {n}_{i} - {n}_{1} ) \qquad [ Equation 9 ]$$

In Equation 9, c is the speed of light, {xₜ, yₜ} are (unknown) coordinates of a target UE, {xᵢ, yᵢ} are (known) coordinates of a TP, and {x₁, y₁} are coordinates of a reference TP (or another TP). Here, (Tᵢ−T₁) is a transmission time offset between two TPs, referred to as “real time differences” (RTDs), and nᵢ and n₁ are UE ToA measurement error values.

E-CID (Enhanced Cell ID)

In a cell ID (CID) positioning method, the position of the UE may be measured based on geographical information of a serving ng-eNB, a serving gNB, and/or a serving cell of the UE. For example, the geographical information of the serving ng-eNB, the serving gNB, and/or the serving cell may be obtained by paging, registration, etc.

The E-CID positioning method may use additional UE measurement and/or NG-RAN radio resources in order to improve UE location estimation in addition to the CID positioning method. Although the E-CID positioning method partially may utilize the same measurement methods as a measurement control system on an RRC protocol, additional measurement only for UE location measurement is not generally performed. In other words, an additional measurement configuration or measurement control message may not be provided for UE location measurement. The UE does not expect that an additional measurement operation only for location measurement will be requested and the UE may report a measurement value obtained by generally measurable methods.

For example, the serving gNB may implement the E-CID positioning method using an E-UTRA measurement value provided by the UE.

Measurement elements usable for E-CID positioning may be, for example, as follows.
UE measurement: E-UTRA reference signal received power (RSRP), E-UTRA reference signal received quality (RSRQ), UE E-UTRA reception (Rx)-transmission (Tx) time difference, GERAN/WLAN reference signal strength indication (RSSI), UTRAN common pilot channel (CPICH) received signal code power (RSCP), and/or UTRAN CPICH Ec/Io
E-UTRAN measurement: ng-eNB Rx-Tx time difference, timing advance (TADv), and/or AoA

Here, TADV may be divided into Type 1 and Type 2 as follows.

T_{ADV} Type 1=(ng-eNB Rx-Tx time difference)+(UE E-UTRA Rx-Tx time difference)

TADv Type 2=ng-eNB Rx-Tx time difference

AoA may be used to measure the direction of the UE. AoA is defined as the estimated angle of the UE counterclockwise from the eNB/TP. In this case, a geographical reference direction may be north. The eNB/TP may use a UL signal such as an SRS and/or a DMRS for AoA measurement. The accuracy of measurement of AoA increases as the arrangement of an antenna array increases. When antenna arrays are arranged at the same interval, signals received at adjacent antenna elements may have constant phase rotate.

Multi RTT (Multi-cell RTT)

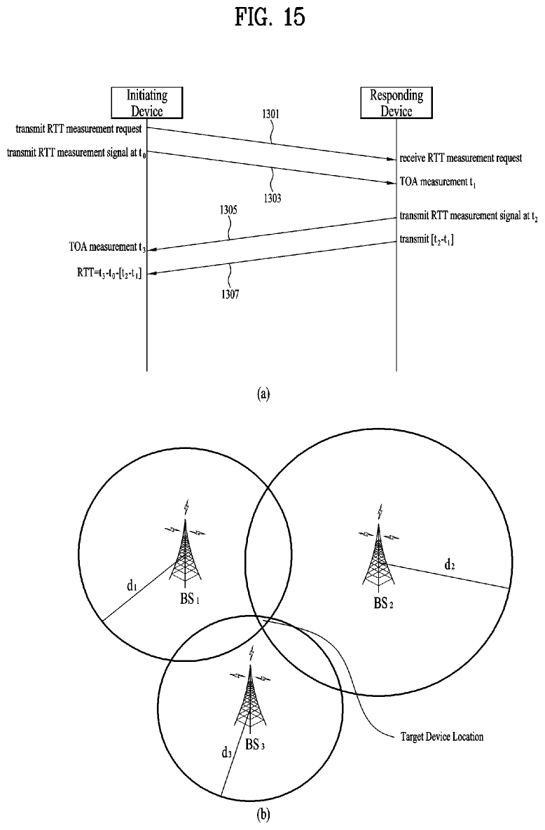

FIG. 15 is a diagram illustrating an exemplary multi-round trip time (multi-RTT) positioning method to which various embodiments are applicable.

Referring to FIG. 15(a), an exemplary RTT procedure is illustrated, in which an initiating device and a responding device perform ToA measurements, and the responding device provides ToA measurements to the initiating device, for RTT measurement (calculation). The initiating device may be a TRP and/or a UE, and the responding device may be a UE and/or a TRP.

In operation 1301 according to various embodiments, the initiating device may transmit an RTT measurement request, and the responding device may receive the RTT measurement request.

In operation 1303 according to various embodiments, the initiating device may transmit an RTT measurement signal at t0 and the responding device may acquire a ToA measurement t1.

In operation 1305 according to various embodiments, the responding device may transmit an RTT measurement signal at t2 and the initiating device may acquire a ToA measurement t3.

In operation 1307 according to various embodiments, the responding device may transmit information about [t2−t1], and the initiating device may receive the information and calculate an RTT by Equation 10. The information may be transmitted and received based on a separate signal or in the RTT measurement signal of operation 1305.

RTT=t₃−t₀−[₂−t₁] [Equation 10]

Referring to FIG. 15(b), the RTT may correspond to a double-range measurement between the two devices. Positioning estimation may be performed from the information. Based on the measured RTT, d1, d2 and d3 may be determined, and a target device location may be determined to be the intersection of circles with BS1, BS2, and BS3 (or TRPs) at the centers and radiuses of d1, d2 and d3.

2.7. Sounding Procedure

In a wireless communication system to which various embodiments are applicable, an SRS for positioning may be used.

An SRS-Config information element (IE) may be used to configure SRS transmission. (A list of) SRS resources and/or (a list of) SRS resource sets may be defined, and each resource set may be defined as a set of SRS resources.

The SRS-Config IE may include configuration information on an SRS (for other purposes) and configuration information on an SRS for positioning separately. For example, configuration information on an SRS resource set for the SRS (for other purposes) (e.g., SRS-ResourceSet) and configuration information on an SRS resource set for the SRS for positioning (e.g., SRS-PosResourceSet) may be included separately. In addition, configuration information on an SRS resource for the SRS (for other purposes) (e.g., SRS-ResourceSet) and configuration information on an SRS resource for the SRS for positioning (e.g., SRS-PosResource) may be included separately.

An SRS resource set for positioning may include one or more SRS resources for positioning. Configuration information on the SRS resource set for positioning may include: information on an identifier (ID) that is assigned/allocated/related to the SRS resource set for positioning; and information on an ID that is assigned/allocated/related to each of the one or more SRS resources for positioning. For example, configuration information on an SRS resource for positioning may include an ID assigned/allocated/related to a UL resource. In addition, each SRS resource/SRS resource set for positioning may be identified based on each ID assigned/allocated/related thereto.

The SRS may be configured periodically/semi-persistently/aperiodically.

An aperiodic SRS may be triggered by DCI. The DCI may include an SRS request field.

Table 11 shows an exemplary SRS request field.

TABLE 11

| | Triggered aperiodic SRS | |
|---|---|---|
| | resource set(s) for DCI format | Triggered aperiodic SRS |
| | 0_1, 0_2, 1_1, 1_2, and 2_3 | resource set(s) for DCI format |
| | configured with higher layer | 2_3 configured with higher layer |
| Value of SRS | parameter srs-TPC-PDCCH- | parameter srs-TPC-PDCCH- |
| request field | Group set to ‘typeB’ | Group set to ‘type A’ |
| 00 | No aperiodic SRS resource set | No aperiodic SRS resource set |
| | triggered | triggered |
| 01 | SRS resource set(s) configured | SRS resource set(s) configured |
| | by SRS-ResourceSet with higher | with higher layer parameter |
| | layer parameter aperiodicSRS- | usage in SRS-ResourceSet set |
| | ResourceTrigger set to 1 or an | to ‘antennaSwitching’ and |
| | entry in aperiodicSRS- | resourceType in SRS-ResourceSet |
| | ResourceTriggerList set to 1 | set to ‘aperiodic’ for a 1^{st} set |
| | SRS resource set(s) configured | of serving cells configured by |
| | by SRS-PosResourceSet with | higher layers |
| | an entry in aperiodicSRS- | |
| | ResourceTriggerList set to 1 | |
| | when triggered by DCI formats | |
| | 0_1, 0_2, 1_1, and 1_2 | |
| 10 | SRS resource set(s) configured | SRS resource set(s) configured |
| | by SRS-ResourceSet with higher | with higher layer parameter |
| | layer parameter aperiodicSRS- | usage in SRS-ResourceSet set |
| | ResourceTrigger set to 2 or an | to ‘antennaSwitching’ and |
| | entry in aperiodicSRS- | resourceType in SRS-ResourceSet |
| | ResourceTriggerList set to 2 | set to ‘aperiodic’ for a 2^{nd} set |
| | SRS resource set(s) configured | of serving cells configured by |
| | by SRS-PosResourceSet with | higher layers |
| | an entry in aperiodicSRS- | |
| | ResourceTriggerList set to 2 | |
| | when triggered by DCI formats | |
| | 0_1, 0_2, 1_1, and 1_2 | |
| 11 | SRS resource set(s) configured | SRS resource set(s) configured |
| | by SRS-ResourceSet with higher | with higher layer parameter |
| | layer parameter aperiodicSRS- | usage in SRS-ResourceSet set to |
| | ResourceTrigger set to 3 or an | ‘antennaSwitching’ and |
| | entry in aperiodicSRS- | resourceType in SRS-ResourceSet |
| | ResourceTriggerList set to 3 | set to ‘aperiodic’ for a 3^{rd} set |
| | SRS resource set(s) configured | of serving cells configured by |
| | by SRS-PosResourceSet with | higher layers |
| | an entry in aperiodicSRS- | |
| | ResourceTriggerList set to 3 | |
| | when triggered by DCI formats | |
| | 0_1, 0_2, 1_1, and 1_2 | |

In Table 11 srs-TPC-PDCCH-Group is a parameter for setting the triggering type for SRS transmission to type A or type B, aperiodicSRS-ResourceTriggerList is a parameter for configuring an additional list of DCI code points where the UE needs to transmit the SRS according to the SRS resource set configuration, aperiodicSRS-ResourceTrigger is a parameter for configuring a DCI code point where the SRS needs to be transmitted according to the SRS resource set configuration, and resourceType is a parameter for configuring (periodic/semi-static/aperiodic) time domain behavior of the SRS resource configuration.

3. Various Embodiments

A detailed description will be given of various embodiments based on the above technical ideas. The afore-described contents of Section 1 and Section 2 are applicable to various embodiments described below. For example, operations, functions, terminologies, and so on which are not defined in various embodiments may be performed and described based on Section 1 and Section 2.

Symbols/abbreviations/terms used in the description of various embodiments may be defined as follows.
A/B/C: A and/or B and/or C
comb: The comb may refer to a method of mapping a signal at a predetermined interval in the frequency domain. For example, comb 2 (comb-2 or 2-comb) may refer to mapping of the same specific DM-RS port to each RE spaced apart by two subcarriers. For example, comb 4 (comb-4 or 4-comb) may refer to mapping of the same specific DM-RS port to each RE spaced apart by four subcarriers.
CSI-RS channel state information reference signal
LMF: location management function
OTDOA (OTDoA): observed time difference of arrival
PRS: positioning reference signal
RS: reference signal
RTT: round trip time
RSTD: reference signal time difference/relative signal time difference
SRS: sounding reference signal. According to various embodiments, the SRS may be used for UL channel estimation and for positioning measurement using multi input multi output (MIMO). In other words, according to various embodiments, the SRS may include a normal SRS and a positioning SRS. According to various embodiments, a positioning SRS may be understood as a UL RS configured for position of a UE and/or used for positioning of the UE. According to various embodiments, a normal SRS may be in contrast to the positioning SRS and may be understood as a UL RS configure for UL channel estimation and/or used for UL channel estimation (and/or configured for UL channel estimation and positioning and/or used for UL channel estimation and positioning). According to various embodiments, the positioning SRS may also be referred to as an SRS for positioning or the like. In a description of various embodiments, terms such as positioning SRS and SRS for positioning may be used interchangeably and may be understood to have the same meaning. According to various embodiments, the normal SRS may also be referred to as a legacy SRS, a MIMO SRS, an SRS for MIMO, or the like. In a description of various embodiments, terms such as a normal SRS, a legacy SRS, a MIMO SRS, and an SRS for MIMO may be used interchangeably and may be understood to have the same meaning. For example, the normal SRS and the positioning SRS may be separately configured/indicated. For example, the normal SRS and the positioning SRS may be configured/indicated from different information elements (IEs) of a higher layer. For example, the normal SRS may be configured based on an SRS-resource. For example, the positioning SRS may be configured based on an SRS-PosResource. In a description of various embodiments, an SRS resource set may be defined as a set of one or more SRS resources. For example, each SRS resource may have an SRS resource identifier (ID). For example, each SRS resource set may have an SRS resource set ID.
SS: synchronization signal
SSB: synchronization signal block
SS/PBCH: synchronization signal/physical broadcast channel
TA: timing advance/time advance
TDOA (TDoA): timing difference of arrival
TOA (ToA): time of arrival
TRP: transmission and reception point (TP: transmission point)
UTDOA (UTDoA): uplink time difference of arrival

In a description of various embodiments, a base station (BS) may be understood as a generic term including a remote radio head (RRH), an eNB, a gNB, a TP, a reception point (RP), a relay, and the like.

In a description of various embodiments, above anything greater than/above A may be replaced by something above/greater than A.

In a description of various embodiments, anything less than/below B may be replaced by something below/less than B.

Unless otherwise noted, an operation of a UE according to various embodiments may be configured/directed from the BS/location server/LMF.

Unless otherwise noted, in a description of various embodiments, timing measurement may refer to any kind of timing measurement to be utilized/used for UE positioning, such as TOA, RSTD, UE RX-TX time difference, and gNB RX-TX time difference.

Unless otherwise noted, in a description of various embodiments, the SRS may be an SRS for positioning use for UE positioning and may include an SRS resource and/or an SRS resource set. However, various embodiments are not limited thereto, and may be applied to various SRSs (including normal SRS, SRS resources, and/or SRS resource sets) for other uses such as beam alignment, CSI acquisition, codebook/non-codebook-based data transmission, etc.

For example, in positioning of a wireless communication system to which various embodiments are applicable (e.g., a Release-16 wireless communication system), use of a specific DL RS transmitted from a neighboring cell/BS/TRP as a path-loss reference RS may be supported for the UE to determine SRS transmission power in consideration of the neighboring cell/BS/TRP. And/or, for example, in a wireless communication system to which various embodiments are applicable, use of a specific DL RS resource transmitted from a neighboring cell/BS/TRP as spatial relation information (and/or UL TCI) may be supported.

However, in positioning of a wireless communication system to which various embodiments are applicable, a configuration for a path-loss reference RS may be an optional parameter, and thus a cell/BS/TRP may or may not configure the path-loss reference RS to the UE. For example, when the path-loss reference RS is not configured to the UE, even if a beam is configured/indicated to the UE in order to transmit an SRS to a specific neighboring cell/BS/TRP as a target, an operation of the UE for determining the path-loss reference may be ambiguous.

Various embodiments may be related to determination of a path-loss reference for control of SRS transmission power. For example, various embodiments may be related to a method of determining path-loss reference for determining transmission power for a specific SRS resource and/or an SRS resource set by the UE when a path-loss reference required for determining SRS transmission power by the UE is not configured.

For example, various embodiments may be related to a default/fallback operation of the UE when a path-loss reference for a positioning SRS is not configured/indicated. For example, when the UE is configured/indicated to transmit a specific SRS resource to a specific neighboring cell/BS/TRP as a target, and is not configured/indicated with a path-loss reference RS for an SRS resource set including an SRS resource, the UE may use information on a specific neighboring cell/BS/TRP configured/indicated as the spatial relation information for the SRS resource (e.g., an identifier (ID)) and/or a DL RS resource ID as a path-loss reference. This is an example according to various embodiments, and in a description of various embodiments to be described below, various embodiments including the same will be described.

Various embodiments may be related to an SRS power control method in consideration of a neighboring cell/BS/TRP.

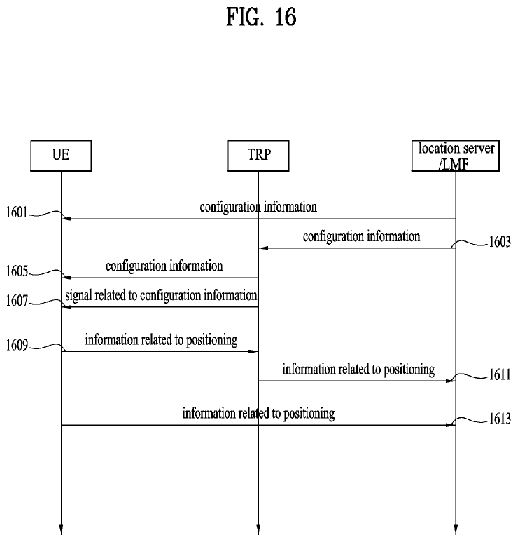

FIG. 16 is a simplified diagram illustrating an operating method of a UE, a TRP, a location server, and/or an LMF according to various embodiments.

Referring to FIG. 16, in operation 1601 according to various embodiments, the location server and/or the LMF may transmit configuration indicated to the UE and the UE may receive the configuration information.

In operation 1603 according to various embodiments, the location server and/or the LMF may transmit reference configuration information to the TRP and the TRP may receive the reference configuration information. In operation 1605 according to various embodiments, the TRP may transmit the reference configuration information to the UE and the UE may receive the reference configuration information. In this case, operation 1601 according to various embodiments may be omitted.

In contrast, operations 1603 and 1605 according to various embodiments may be omitted. In this case, operation 1601 according to various embodiments may be performed.

That is, operation 1601 according to various embodiments, and operations 1603 and 1605 according to various embodiments may be selectively performed.

In operation 1607 according to various embodiments, the TRP may transmit a signal related to the configuration information and the UE may receive the signal related to the configuration information. For example, the signal related to the configuration information may be a signal for positioning of the UE.

In operation 1609 according to various embodiments, the UE may transmit a signal related to positioning to the TRP and the TRP may receive the signal related to positioning. In operation 1611 according to various embodiments, the TRP may transmit the signal related to positioning to the location server and/or the LMF and the location server and/or the LMF may receive the signal related to positioning.

In operation 1613 according to various embodiments, the UE may transmit the signal related to positioning to the location server and/or the LMF and the location server and/or the LMF may receive the signal related to positioning. In this case, operations 1609 and 1611 according to various embodiments may be omitted.

In contrast, operation 1613 according to various embodiments may be omitted. In this case, operations 1609 and 1611 according to various embodiments may be performed.

That is, operations 1609 and 1611 according to various embodiments, and operation 1613 according to various embodiments may be selectively performed.

According to various embodiments, the signal related to positioning may be obtained based on the configuration information and/or the signal related to the configuration information.

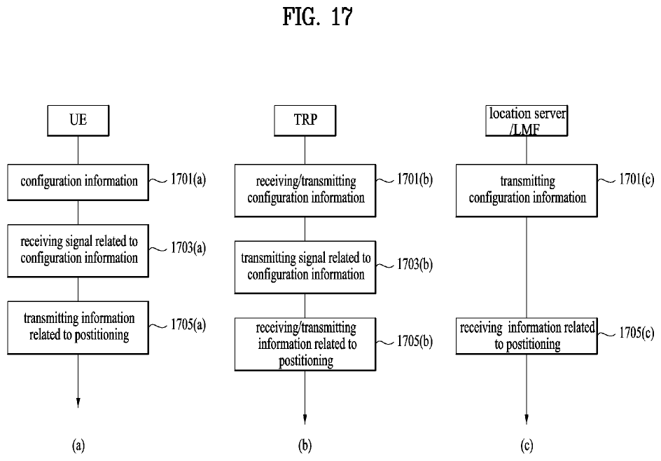

FIG. 17 is a simplified diagram illustrating an operating method of a UE, a TRP, a location server, and/or an LMF according to various embodiments.

Referring to FIG. 17(a), in operation 1701(a) according to various embodiments, the UE may receive configuration information.

In operation 1703(a) according to various embodiments, the UE may receive a signal related to the configuration information.

In operation 1705(a) according to various embodiments, the UE may transmit information related to positioning.

Referring to FIG. 17(b), in operation 1701(b) according to various embodiments, the TRP may receive configuration information from the location server and/or the LMF and transmit the configuration information to the UE.

In operation 1703(b) according to various embodiments, the TRP may transmit a signal related to the configuration information.

In operation 1705(b) according to various embodiments, the TRP may receive information related to positioning and transmit the information related to positioning to the location server and/or the LMF.

Referring to FIG. 17(c), in operation 1701(c) according to various embodiments, the location server and/or the LMF may transmit configuration information.

In operation 1705(c) according to various embodiments, the location server and/or the LMF may receive information related to positioning.

For example, the above-described configuration information may be understood as relating to reference configuration (information) or one or more pieces of information that the location server, the LMF, and/or the TRP transmits to/configures for the UE and/or may be understood as the reference configuration (information) or one or more pieces of information that the location server, the LMF, and/or the TRP transmits to/configures for the UE, in a description of various embodiments below.

For example, the above signal related to positioning may be understood as a signal related to one or more pieces of information that the UE reports and/or a signal including one or more pieces of information that the UE reports, in a description of various embodiments below.

For example, in a description of various embodiments below, the BS, the gNB, and the cell may be replaced with the TRP, the TP, or any device serving equally as the TRP or the TP.

For example, in a description of various embodiments below, the location server may be replaced with the LMF and any device serving equally as the LMF.

More detailed operations, functions, terms, etc. in operation methods according to various embodiments may be performed and described based on various embodiments described later. The operation methods according to various embodiments are exemplary and one or more operations in the above-described operation methods may be omitted according to detailed content of each embodiment.

Hereinafter, various embodiments will be described in detail. It may be understood by those of ordinary skill in the art that the various embodiments described below may be combined in whole or in part to implement other embodiments unless mutually exclusive.

For example, SRS transmission power control may be described with reference to Table 12 below. For example, Table 12 may include content related to power control for transmission of a normal SRS (corresponding to SRS-Config and/or SRS-ResourceSet) related to multi input multi output (MIMO), such as beam management, CSI acquisition, and codebook/non-codebook-based transmission and content related to power control for transmission of a positioning SRS (corresponding to SRS-Positioning-Config and/or SRS-PosResourceSet) used for positioning.

TABLE 12
7.3 Sounding reference signals
For SRS, a UE splits a linear value \hat{P}_{SRS,b,f,c}(i, q, l) of the transmit power P_{SRS,b,f,c}(i, q, l) on active UL BWP b of carrier f of
serving cell c equally across the configured antenna ports for SRS.
7.3.1 UE behaviour
If a UE transmits SRS based on a configuration by SRS-ResourceSet on active UL BWP b of carrier f of serving cell c
using SRS power control adjustment state with index l, the UE determines the SRS transmission power P_{SRS,b,f,c}(i, q, l) in
SRS transmission occasion i as
$P \text{?} ( i , q , l ) = \text{?} \{ \begin{matrix}{P}_{CMAX , f , c} ( i ) , \\ \begin{matrix}{P}_{O\_SRS , b , f , c} ( {q}_{i} ) + 10 {log}_{10} ( {2}^{p} \cdot {M}_{SRS , b , f , c} ( f ) ) + \\ {α}_{SRS , b , f , c} ( {q}_{i} ) \cdot {PL}_{b , f , c} ( {q}_{i} ) + {h}_{b , f , c} ( t , l )\end{matrix}\end{matrix} \} [ dBm ]$
where,

| | |
|---|---|
| - | P [symbol] (i) is the UE configured maximum output power defined in [8, TS 38.101-1], [8-2, TS38.101-2] and [TS |
| | 38.101-3] for carrier f of serving cell c in SRS transmission occasion i |
| - | P_{O,SRS,b,f,c}(qᵢ) is provided by p0 for active UL BWP b of carrier f of serving cell c and SRS resource set qₛ |
| | provided by SRS-ResourceSet and SRS-ResourceSetId |
| - | M_{SRS,b,f,c}(i) is a SRS bandwidth expressed in number of resource blocks for SRS transmission occasion i on active UL |
| | BWP b of carrier f of serving cell c and μ is a SCS configuration defined in [4, TS 38.211] |
| - | αSRS,b,f,c(qₛ) is provided by alpha for active UL BWP b of carrier f of serving cell c and SRS resource set qₛ |
| - | PL_{b,f,c} (q_{d}) is a downlink pathloss estimate in dB calculated by the UE using RS resource index q_{d} as described in |
| | Clause 7.1.1 for the active DL BWP of serving cell c and SRS resource set qₛ [6, TS 38.214]. The RS resource index |
| | q_{d} is provided by pathlossRefereaceRS associated with the SRS resource set qₛ and is either an ssb-Index providing a |
| | SS/PBCH block index or a csi-RS-lndex providing a CSI-RS resource index if the UE is provided enabkPL-RS- |
| | UpdateForPUSCH-SRS, a MAC CE [11. TS .38.321] can provide by SRS-PathlossReferenceRS-Id a corresponding RS |
| | resource index q_{d} for aperiodic or semi-persistent SRS resource set qₛ |
| - | If the UE is not provided pathlossReferenceRS or SRS-PathlossReferenceRS-Id, or before the UE is provided |
| | dedicated higher layer parameters. the UE calculates PL [symbol] using a RS resource obtained from an SS/PBCH |
| | block with same SS/PBCH block index as the one the UE uses to obtain MIB |
| - | if the UE is not provided pathlossReferenceLinking, the RS resource is on a serving cell indicated by a value of |
| | pathlossReferenceLinking |
| - | If the UE |
| | - is not provided pathlossReferenceRS or SRS-PathlossReferencesRS-Id, |
| | - is not provided spatialRelationInfo, and |
| | - is provided enableDefaultBeamPL-ForSRS, and |
| | - is not provided coresetPoolIndex value of 1 for any CORESET, or is provided coresetPoolIndex value of 1 for all |
| | CORESETs in ControlResourceSet and no codepoint of a TCI field, if any, in a DCI format of any search space |
| | set maps to two TCI states [5, TS 38.212] |
| | the UE determines a RS resource index q_{d} providing a periodic RS resource configured with qel-Type set to ′typeD′ in |
| | - the TCI state or the QCL assumption of a CORESET with the lowest index in the active DL BWP, if CORESETs |
| | are provided in the active DL BWP of serving cell c |
| | - the active PDSCH TCI state with lowest ID [6, TS 38.214] in the active DL BWP, if CORESETs are not provided |
| | in the active DL BWP of serving cell c |
| - | For the SRS power control adjustment state for active UL BWP b of carriers f of serving cell c and SRS |
| | transmission occasion i |
| | - h [symbol] − f [symbol] (i,l), where , f_{b,f,c}(i,l) is the current PUSCH power control adjustment state as described in Clause |
| | 7.1.1, if srs-PowerControlAdjustmentStates indicates a same power control adjustment state for SRS transmissions |
| | and PUSCH transmissions; or |
| | - $h \text{?} ( i ) = h \text{?} ( i - {i}_{o} ) + {\sum }_{\text{?}}^{\text{?}} {δ}_{SRS , b , f , c} ( m ) if the UE is not configured for PUSCH transmissions on active UL BWP b of$ |
| | carrier f of serving cell c, or if srs-powerControlAdjustmentsStates indicates separate power control adjustment |
| | states between SRS transmissions and PUSCH transmissions, and if tpc-Accuwulation is not provided, where |
| | - The δ_{SRS,b,f,c} values are given in Table 7.1.1-1 |
| | - δ_{SRS,b,f,c}(m) is jointly coded with other TPC commands in a PDCCH with DCI format 2_3, as described in Clause |
| | 11.4 |
| | - ${\sum }_{\text{?}}^{\text{?}} {δ}_{SRS , b , f , c} ( m ) is a sum of TPC command values in a set {S}_{i} of TPC command values with cardinality \text{?} ( {S}_{i} ) that$ |
| | the UE receives between [symbol] symbols before SRS transmission occasion i − iₒ and K_{SRS}(i) symbols before |
| | SRS transmission occasion i on active UL BWP b of carrier f of serving cell c for SRS power control |
| | adjustment state, where iₛ > 0 is the smallest integer for which K_{SRS}(i − iₒ) symbols before SRS transmission |
| | occasion i − iₒ is earlier than K_{SRS}(i) symbols before SRS transmission occasion i |
| | - if the SRS transmission is aperiodic, K_{SRS}(i) is a number of symbols for active UL BWP b of carrier f of |
| | serving cell c after a last symbol of a corresponding PDCCH triggering the SRS transmission and before a first |
| | symbol of the SRS transmission |
| | - if the SRS transmission is semi-persistent or periodic, K_{SRS}(i) is a number of K [symbol] symbols equal to the product |
| | of a number of symbols per slot, [symbol] and the minimum of the values provided by 1:2 in PUSCH-ConfigCommon |
| | for active UL BWP b of carrier f of serving cell c |
| | - If the UE has reached maximum power for active UL BWP b of carrier f of serving cell c at SRS |
| | $transmission occasion i - {i}_{o} and {\sum }_{\text{?}}^{\text{?}} {δ}_{SRS , b , f , c} ( m ) \geq 0 , then {h}_{b , f , c} ( i ) = {h}_{b , f , c} ( i - {i}_{o} )$ |
| | - If UE has reached minimum power for active UL BWP b of carrier f of serving cell C at SRS transmission |
| | $occasion i - {i}_{o} and {\sum }_{\text{?}}^{\text{?}} {δ}_{SRS , b , f , c} ( m ) \geq 0 , then {h}_{b , f , c} ( i ) = {h}_{b , f , c} ( i \text{?} {i}_{o} )$ |
| | - If a configuration for a P_{O SRS,b,f,c}(q_{c}) value or for a α_{SRS,b,f,c}(qₛ) value for a corresponding SRS power control |
| | adjustment state l for active UL BWP b of carrier f of serving cell c is provided by higher layers |
| | - h_{b,f,c}(k) = 0, k = 0, 1, . . . , i |
| | - Else |
| | - h_{b,f,c}(0) = ΔP [symbol] + δ [symbol] |
| | where |
| | δ [symbol] is the TPC command value indicated in the random access response grant corresponding to the |
| | random access preamble that the UE transmitted on active UL BWP b of earner f of the serving cell c, and |
| | $Δ P \text{?} = min [ \begin{matrix}max ( \begin{matrix}0 , \\ \begin{matrix}P \text{?} - ( P \text{?} ( {q}_{c} ) \div 10 {log}_{10} ( {2}^{p} \cdot {M}_{SRS , b , f , c} ( f ) ) + \\ {α}_{SRS , b , f , c} ( {q}_{c} ) \cdot {PL}_{b , f , c} ( {q}_{c} )\end{matrix}\end{matrix} \\ Δ P \text{?}\end{matrix} ) ]$ |
| | where ΔP [symbol] is provided by higher layers and corresponds to the total power ramp-up requested by |
| | higher layers from the first to the last preamble for active UL BWP b of carrier f of serving cell c. |
| | - [symbol] if the UE is not configured for PUSCH transmissions on active UL BWP b of carrier j of serving |
| | cell c, or if srs-PowerControlAdjustmentStates indicates separate power control adjustment states between SRS |
| | transmissions and PUSCH transmissions, and tpc-Accumulation is provided, and the UE detects a DCI format 2_3 |
| | [symbol] symbols before a first symbol of SRS transmission occasion i, where absolute values of [symbol] are |
| | provided in f able 7.1.1-1 |
| | - if srs-PowerControlAdjustmentStates indicates a same power control adjustment state for SRS transmissions and |
| | PUSCH transmissions, the update of the power control adjustment state for SRS transmission occasion i occurs at |
| | the beginning of each SRS resource in the SRS resource set q [symbol] ; otherwise, the update of the power control |
| | adjustment state SRS transmission occasion i occurs at the beginning of the first transmitted SRS resource in the |
| | SRS resource set [symbol] . |

If a UE transmits SRS based on a configuration by SRS-PosResourceSet on active UL BWP b of carrier f of serving cell c,
the UE determines the SRS transmission power P_{SRS,b,f,c}(i,q) in SRS transmission occasion i as

$P \text{?} ( i , {q}_{i} ) = min \{ \begin{matrix}{P}_{CMAX , f , c} ( \text{?} ) , \\ \begin{matrix}{P}_{O\_SRS , b , f , c} ( {q}_{i} ) + 10 {log}_{10} ( {2}^{p} \cdot {M}_{SRS , b , f , c} ( \text{?} ) ) + \\ {α}_{SRS , b , f , c} ( {q}_{i} ) \cdot {PL}_{b , f , c} ( {q}_{i} )\end{matrix}\end{matrix} \} [ dBm ]$

where,

```
  - P_{O}_SRS,b,r,c(Qₛ) and α_{SRS,b,f,c}(qₛ) are provided by p0-r16 and alpha-r16 respectively, for active UL BWP b of carrier
    f of serving cell c, and SRS resource set qₛ is indicated by SRS-PosResourceSetId from SRS-PosResourceSet, and
  - PL_{b,f,c}(q_{d}) is a downlink pathloss estimate in dB calculated by the UE, as described in Clause 7.1.1 in case of an active
    DL BWP of a serving cell c, using RS resource indexed q_{d} in a serving or non-serving cell for SRS resource set qₛ [6,
    TS 38.214]. A configuration for RS resource index associated with SRS resource set qₛ is provided by
    pathlossReferenceRS-Pos
  - if a ssb-bidexNcell is provided, referenceSignalPower is provided by ss-PBCH-BlockPower-r16
  - if a dl-PRS-ResourcedId is provided. referenceSignalPower is provided by dl-PRS-ResourcePower
If the UE determines that the UE is not able to accurately measure PL_{b,f,c}(q_{d}), or the UE is not provided with
pathlossReferenceRS-Pos, the UE calculates PL_{b,f,c}(q_{d}) using a RS resource obtained from the SS/PBCH block of the
serving cell that the UE uses to obtain MIB
The UE indicates a capability for a number of pathloss estimates that the UE can simultaneously maintain for all SRS
resource sets provided by SRS-PosResourceSet in addition to the up to four pathloss estimates that the UE maintains per
serving cell for PUSCH/PUCCH transmissions and for SRS transmissions configured by SRS-Resource.
```

[symbol]

indicates data missing or illegible when filed

Hereinafter, various embodiments related to determination of a path-loss reference related to control of SRS transmission power will be described.

For example, information element (IE) SRS-Config may be used to configure SRS measurement for transmission of an SRS and/or cross link interference (CLI). For example, the corresponding configuration may define a list of SRS resources and/or a list of SRS resource sets. For example, each resource set may define a set of SRS resources. For example, a network may trigger transmission of a set of SRS-resources using the configured aperiodicSRS-ResourceTrigger (layer 1 downlink control information (L1 DCI)).

For example, the IE pathlossReferenceRS may be related to a reference signal used for SRS path-loss estimation.

For example, in order to measure/estimate the location of the UE using a UTDOA method and/or a Multi-RTT-based UE positioning method, the BS/location server/LMF may configure/indicate an SRS resource and/or an SRS resource set to the UE. For example, the SRS resource and/or the SRS resource set may be periodic(P)/semi-persistent (SP)/aperiodic (A)).

Proposal #1

According to various embodiments, when a path-loss reference is not configured/indicated to a specific SRS resource set, the following fallback behavior may be considered to determine the path-loss reference. An operation of a UE according to various embodiments may be configured/indicated by a BS/location server/LMF.

For example, the SRS resource set may be an SRS resource set for an SRS for positioning purpose. For example, the SRS resource set may be configured/indicated by higher layer signaling “SRS-PosResourceSet-r16”.

Unless specifically stated otherwise or contradictory, in a description of various embodiments, the SRS resource set may be replaced with an SRS resource. Unless specifically stated otherwise or contradictory, in a description of various embodiments, the SRS resource may be replaced with an SRS resource set.

Alt.1 (Using Spatial Relation Information)

According to various embodiments, when spatial relation information and/or a UL transmission configuration index (TC) are configured/indicated (in the following description of various embodiments, unless otherwise noted, spatial relation information may be replaced with spatial relation information and/or UL TCI) among SRS resources included in an SRS resource set in which a path-loss reference is not configured, the configured spatial relation information and/or UL TCI may be used to determine/acquire a DL path-loss reference for transmission of an SRS resource.

In more detail, one or more of operations of a UE according to various embodiments may be considered.

Case 1

According to various embodiments, when a specific DL PRS resource is configured/indicated in spatial relation information and/or UL TCI of the SRS resource included in the SRS resource set in which the path-loss reference is not configured/indicated, the UE may use an identifier (ID) of the DL PRS resource and/or a cell/BS/TRP (serving cell/BS/TRP and/or neighboring cell/BS/TRP) in which the DL PRS resource is transmitted (e.g., a physical cell identifier (PCID), and/or a TRP ID, and/or a dl-PRS-ID) as a path-loss reference for determining transmission power.

According to various embodiments, the UE may know in which cell/BS/TRP the DL PRS resource configured as spatial relation information and/or UL TCI is transmitted. Accordingly, according to various embodiments, the UE may use the DL PRS resource and/or cell/BS/TRP information (e.g., identifier, hereinafter the same) as a path-loss reference for determining SRS resource transmission power.

Case 2

According to various embodiments, when a specific SS/PBCH block and/or cell/BS/TRP information for transmitting the SS/PBCH block are configured/indicated in spatial relation information and/or UL TCI of an SRS resource included in an SRS resource set in which a path-loss reference is configured/indicated, the UE may use the SS/PBCH block (and/or cell/BS/TRP information) as a path-loss reference for determining transmission power of the SRS resource.

Case 3

According to various embodiments, when specific SRS resource information is configured/indicated in a source RS of spatial relation information and/or UL TCI of a target SRS resource (an SRS resource to be transmitted is called a target SRS resource for convenience) included in an SRS resource set in which a path-loss reference is not configured/indicated (and/or in UL TCI), the UE may use path-loss reference information configured/indicated in an SRS resource set including an SRS resource configured as a source of the spatial relation information and/or UL TCI as path-loss reference information for determining transmission power of the target SRS resource.

Case 4

According to various embodiments, when specific SRS resource information is configured/indicated in a source RS of spatial relation information and/or UL TCI of a target SRS resource included in an SRS resource set in which a path-loss reference is not configured/indicated (and/or in UL TCI), the UE may use an SSB for acquiring a master information block (MIB) as path-loss reference information for determining transmission power of the target SRS resource.

Case 5

According to various embodiments, when there is no configuration of spatial relation information and/or UL TCI of a target SRS resource included in an SRS resource set in which a path-loss reference is configured/indicated, the UE may use an SSB for acquiring an MIB as a path-loss reference.

For example, unlike the path-loss reference RS configuration for a normal SRS by SRS-Config, a path-loss reference RS transmitted from an adjacent cell/BS/TRP may be configured as an path-loss reference RS for an SRS for positioning according to SRS-PosResource-r16 and/or SRS-PosResourceSetId-r16. This is because, for example, SRS transmission is intended for a specific neighboring cell/BS/TRP.

For example, when the path-loss reference RS is not configured for an SRS resource set, a method of determining a path-loss reference of a UE may be required.

For example, considering that the path-loss reference RS is configured/indicated for each SRS resource set, the cell/BS/TRP may be configured to transmit an SRS resource (for positioning) in an SRS resource set to a specific target physical cell/BS/TRP (a physical cell/BS/TRP to which a SRS is to be transmitted is referred to as a target physical cell/BS/TRP for convenience). For example, even if a path-loss reference RS is not configured/indicated, if spatial relation information for a neighboring cell/BS/TRP is configured, the UE may transmit an SRS using appropriate transmission power to allow the SRS to reach the target neighboring cell/BS/TRP.

According to various embodiments, when a path-loss reference RS for positioning is not provided to the UE (e.g., when pathlossReferenceRS-Pos-r16 is not provided to the UE), the UE may calculate/acquire path-loss (PL_{b,f,c}(q_{d}), refer to Equation 3) using an RS resource (e.g., RS resource configured in SRS-SpatialRelationInfoPos-r16) identified based on configuration information of a spatial relation between a reference RS and a target SRS.

According to various embodiments, when an RS resource (e.g., an RS resource configured in SRS-SpatialRelationInfoPos-r16) identified based on configuration information of a spatial relation between a reference RS and a target SRS is an SRS resource and/or the configuration information (e.g., SRS-SpatialRelationInfoPos-r16) of the spatial relation between the reference RS and the target SRS is not configured, the UE may calculate/acquire path-loss (PL_{b,f,c}(q_{d}), refer to Equation 3) using an RS resource identified from an SS/PBCH block of a serving cell used to obtain an MIB.

For example, definition of pathlossReferenceRS-Pos-r16 and SRS-SpatialRelationInfoPos-r16 is shown in Table 13 below.

TABLE 13
pathlossReferenceRS-Pos
A reference signal (e.g. a SS block or a DL-PRS config) to be used for
SRS path loss estimation (see TS 38.213 [13], clause 7.3).
spatialRelationInfoPos
Configuration of the spatial relation between a reference RS and the target
SRS. Reference RS can be SSB/CSI-RS/SRS/DL-PRS (see TS 38.214
[19], clause 6.2.1).

Alt.2 (Using Associated QCL Information)

According to various embodiments, when an SRS resource included in an SRS resource set in which a path-loss reference is not configured/indicated is configured/indicated as an source RS of a QCL type-D (and/or another QCL type, e.g., a new type of a QCL type-E may be defined) of a specific DL PRS resource, one or more of operations of the UE according to the following various embodiments may be considered.

Alt. 2-1

According to various embodiments, the UE may use the DL PRS resource as a path-loss reference in order to determine transmission power of an SRS resource. And/or, according to various embodiments, the UE may use one or more and/or all of the DL PRS resource and/or cell/BS/TRP information for transmitting the DL PRS resource as path-loss reference information.

Alt. 2-2

According to various embodiments, the UE may select a specific DL PRS resource transmitted in a cell/BS/TRP to which the DL PRS resource is transmitted and may use the selected specific DL PRS resource as a path-loss reference.

Alt.3

According to various embodiments, the UE may use a PRS resource of the minimum and/or maximum index among configured/indicated DL PRS resources as a path-loss reference of an SRS resource in which the path-loss reference is not configured/indicated.

Alt.4 (Zero-Power)

According to various embodiments, when the UE transmits a specific SRS resource set and/or an SRS resource in which a path-loss reference is not configured/indicated, the UE may transmit a zero-power SRS by default (by a default behavior that is predefined/configured/determined without separate configuration/indication). That is, according to various embodiments, the UE may not use transmission power and may not transmit an SRS.

Alt.5 (Indication Power)

According to various embodiments, the UE may be indicated/configured from a BS/location server/LMF for additional information necessary for determining transmission power for a specific SRS resource set and/or SRS resource in which a path-loss reference is not configured. For example, the UE may be configured/indicated with a specific power-offset and/or a specific absolute power value (e.g., dBm unit).

Alt.6 (Using Path-Loss Information of Other SRS Resource Set)

According to various embodiments, the UE may use path-loss reference information configured/indicated in another SRS resource set. According to various embodiments, the UE may use (physical) cell/BS/TRP information configured as a path-loss reference in the other SRS resource set and/or specific DL RS information transmitted in the cell/BS/TRP information as a path-loss reference of a specific SRS resource set in which the path-loss reference is not configured/indicated.

In more detail, for example, when considering the configured/indicated DL path-loss reference, the UE may use path-loss reference information that requires the most path-loss compensation (i.e., transmission power needs to be used as much as possible) as a path-loss reference for an SRS resource set in which the path-loss reference is not configured. For example, a path-loss reference corresponding to maximum path-loss compensation may be used among configured/indicated path-loss references.

In more detail, for example, when considering the configured/indicated DL path-loss reference, the UE may use path-loss reference information that requires the least path-loss compensation (i.e., transmission power is to be used as small as possible) as a path-loss reference for an SRS resource set in which the path-loss reference is not configured. For example, a path-loss reference corresponding to the minimum path-loss compensation may be used among the configured/indicated path-loss references.

Proposal #2 (Priority)

According to various embodiments, when a path-loss reference is determined/selected in order to determine SRS resource transmission power included in a specific SRS resource set in which a path-loss reference is not configured/indicated, (the UE) may consider the following priority:
(The UE) may select/determine the path-loss reference according to a configuration of spatial relation information and/or UL TCI in the specific SRS resource.
When there is no configuration for spatial relation information (and/or UL TCI) in the specific SRS resource and/or when a UL RS is configured as spatial relation information (and/or UL TCI), (the UE) may select/determine a DL PRS resource in which the SRS resource is configured as a QCL source RS as a path-loss reference.
When there is no configuration for spatial relation information (and/or UL TCI) in the specific SRS resource, when a UL RS is configured as spatial relation information (and/or UL TCI), and/or when the SRS resource is not configured as a QCL source of a specific DL PRS resource, the UE may use an SSB in which an MIB is obtained, as a path-loss reference RS.

(Sub-)Proposal ## (Priority)

According to various embodiments, when a path-loss reference is not configured in a specific SRS resource set, the UE may use different path-loss references in different SRS resources included in the SRS resource set.

(Sub-)Proposal ##(Priority)

According to various embodiments, a BS/location server/LMF may configure/indicate only specific (physical) cell/BS/TRP information in the UE as a path-loss reference to be used in a SRS resource set for positioning. That is, according to various embodiments, the specific DL RS may not be specified/indicated, only the (physical) cell/BS/TRP information may be provided to the UE, and the UE may select a specific DL RS to be transmitted in the cell/BS/TRP and may use the specific DL RS as a path-loss reference. And/or, according to various embodiments, the UE may not select a specific DL RS resource as a path-loss reference. According to various embodiments, the UE may know location information of the (physical) cell/BS/TRP, and may calculate/acquire a distance with the (physical) cell/BS/TRP to calculate/acquire a degree by which signal compensation due to path-loss is required.

Proposal #3

According to various embodiments, a BS/location server/LMF may configure/indicate the UE to perform long-term measurement on some and/or all of DL RS resources configured for spatial relation information (and/or UL TCI). For example, the spatial relation information may be related to determination/acquisition of a beam and may correspond to a relatively short-term, and accordingly, may be configured/indicated to perform relatively long-term measurement.

For example, path-loss, etc. may be configured/indicated to be calculated/obtained continuously/average for a DL RS resource configured/indicated as spatial relation information in a specific SRS resource among SRS resources included in a specific SRS resource set. For example, a path-loss reference RS for all SRS resources included in the SRS resource set may be determined as a DL RS resource of spatial relation information configured in a specific SRS resource among SRS resources included in an SRS resource set in which a path-loss reference DL RS is not configured/indicated.

For example, when a path-loss reference DL RS is configured/indicated, this may be in a specific SRS resource set unit. That is, for example, the same path-loss reference may be used for SRS resources included in one SRS resource set, and thus, transmission may be performed on a specific cell/BS/TRP at geographically/physically the same location as a target (which includes the same case within a certain level of error).

For example, an SRS resource for positioning use may be different from a (normal) SRS resource for other uses, and when spatial relation information is configured, only a specific DL RS resource may not be configured, and information related to a specific (physical) cell/BS/TRP to which the DL RS resource is transmitted may be configured together. However, for example, if SRS resources in the specific SRS resource set are configured to perform transmission to different physical/geographical cells/BS/TRP as a target, this may not be appropriate consideration that the same path-loss reference is configured for each set. Therefore, for example, among the SRS resources included in the specific SRS resource set, spatial relation information configured/indicated in the specific SRS resource may be used for other SRS resources included in the SRS resource set.

Proposal #4 (Default Spatial Relation Information)

According to various embodiments, for an SRS resource in which spatial relation information is not configured/indicated among one or more/plural SRS resources included in a specific SRS resource set (for positioning), the UE may use a path-loss reference RS (and/or DL RS and/or physical/geographical cell/BS/TRP information for transmitting the DL RS) information configured/indicated in an SRS resource set included in the SRS resource as spatial relation information of the SRS resource.

According to various embodiments, among one or more/plural SRS resources included in the specific SRS resource set (for positioning), when the physical/geographical cell/BS/TRP information configured/indicated in the spatial relation information of the specific SRS resource is different in a (physical/geographical) cell/BS/TRP to which a DL RS configured/indicated as a path-loss reference RS is transmitted, the UE may use path-loss reference RS information instead of spatial relation information configured/indicated in the SRS resource as spatial relation information of the SRS resource.

Hereinafter, various embodiments related to control of SRS transmission power in consideration of a neighboring cell/BS/TRP will be described. The following various embodiments may be considered as a separate embodiment from the aforementioned embodiment related to the path-loss reference or may also be considered as a combined embodiment therewith.

For example, in a carrier aggregation (CA) and/or dual connectivity (DC) situation, the UE may transmit a specific SRS resource and another UL signal (e.g., PUSCH/PUCCH/PRACH) at the same time in a specific symbol, and when transmission power calculated/obtained to be used in a specific symbol is greater than physical maximum transmission power to be used by the UE, transmission power may be determined according to a predetermined/defined/configured priority rule.

For example, for a single cell operation with two UL carriers and/or a CA operation, if total UE transmit power for PUSCH, and/or PUCCH and/or PRACH and/or SRS transmission in serving cells in a frequency range (FR) in each transmission occasion is greater than preconfigured/defined maximum transmission power of the UE (the maximum transmission power in a transmission occasion), the UE may allocate power (in descending order) according to the following preconfigured/defined priorities for PUSCH and/or PUCCH and/or PRACH and/or SRS transmission. For example, in all symbols within a transmission occasion, the total UE transmission power may be equal to or less than the maximum transmission power of the UE.

[Priority]
PRACH transmission (e.g., PRACH transmission in PCell)
Transmission given a higher priority index among PUCCH or PUSCH transmission
For PUCCH or PUSCH transmission given the same priority index:
   PUCCH transmission having hybrid automatic repeat request-acknowledgement (HARQ-ACK) information and/or scheduling request (SR) and/or location report request (LRR) or PUSCH transmission having HARQ-ACK information
   PUCCH transmission having channel state information (CSI) or PUSCH transmission having CSI
   PUSCH transmission having HARQ-ACK information or CSI and PUSCH transmission (e.g., PUSCH transmission in PCell) (for a type-2 random access procedure and 2-step random access procedure)
SRS transmission (an aperiodic SRS may be semi-persistent and/or may have a higher priority than an SRS) or PRACH transmission in another serving cell that is not a PCell

For example, an SRS resource and/or SRS resource set for UE positioning may be designed in a staggered type of resource element (RE) pattern. For example, in the specific SRS resource, the staggered RE pattern may be designed in such a way that a signal is not seen to be repeated many times in consideration of all time-domain symbols configuring the SRS resource even if different frequency REs are configured to be used across several symbols configuring the SRS resource and a comb-N type of frequency RE pattern is used in a specific symbol. That is, for example, as a result, the staggered RE pattern may be designed to be suitable for acquisition of timing measurement.

For example, a staggered type of RE pattern may be supported as an RE pattern of an SRS used for UE positioning. For example, each OFDM symbol (of an SRS resource) may have a comb-N type frequency RE pattern. That is, for example, each OFDM symbol may show a frequency RE pattern that occupies 1 RE for every N frequency REs. For example, in the staggered RE pattern, the comb-N RE pattern may be used over several symbols, but since the comb-offset (e.g., frequency RE offset) is different for each symbol, one SRS resource configured over several symbols may not occupy only a specific frequency RE, but various frequency REs may be used for every symbol, and thus various frequency REs may be used.

For example, in the case of a positioning SRS resource, in order to effectively combine signals of several symbols in one symbol, when power is uniformly used, it may be more suitable for obtaining accurate timing measurement in terms of a BS than use of unequal power for each frequency RE.

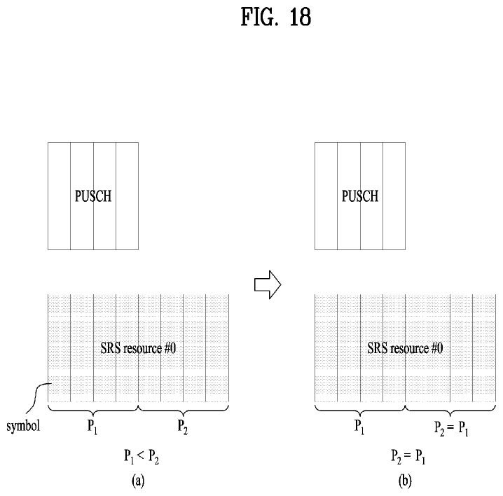

FIG. 18 is a diagram showing an example of a configuration of transmission power according to various embodiments.

For example, referring to FIG. 18(a), when a PUSCH and an SRS resource are configured to be transmitted in the same symbol, if the sum of power calculated/obtained according to a power control method/equation (refer to 1.4. Uplink Power Control) is greater than the maximum power to be used by the UE, SRS transmission power may be reduced. For example, the UE may use more power P2 than power P1 used in an SRS resource symbol that overlaps PUSCH transmission in the SRS resource symbol that does not overlap PUSCH transmission. For example, this may be the case of a normal SRS.

Referring to FIG. 18(b), according to various embodiments, in an SRS resource for positioning, the same transmission power as SRS transmission power reduced to be transmitted in the same symbol as PUSCH/PUCCH/PRACH/SRS (other SRS) may also be used in the same way in the remaining symbols configuring the SRS resource that does not overlap s PUSCH/PUCCH/PRACH/SRS. According to various embodiments, an operation of the UE may be configured/indicated from a BS/location server/LMF. For example, as shown in FIG. 18(a), power of P2 greater than P1 may be used in the remaining symbols that do not overlap a PUSCH among symbols configuring an SRS resource, and in contrast, as shown in FIG. 18(b), the same power (P1=P2) as power in a symbol that overlaps a PUSCH among symbols configuring a SRS resource may also be used in the remaining symbols that do not overlap a PUSCH among symbols configuring SRS resources.

ISSUE #2: Power control enhancement. Closed-loop power control/interference problem.

For example, when an SRS resource for positioning is transmitted (physically), transmission may be performed on not only a serving cell/BS/TRP but also a neighboring cell/BS/TRP as a target, and thus interference problems may be caused in other cell/BS/TRPs that are not the target cell/BS/TRP.

For example, the cell/BS/TRP that is relatively close to a specific UE needs to receive a SRS resource for positioning from a target UE that is relatively far away, and in this regard, an interference problem and/or a received signal level difference is increased to a certain level or more, and a signal of the target UE may not be properly received/invisible.

Proposal ## Closed-Loop Introduction

According to various embodiments, SRS resource-level closed-loop power control may be introduced, and power control may be performed for each TX beam.

According to various embodiments, a path-loss reference RS may be configured for each SRS resource set, and power control may be (additionally) performed for each SRS resource.

According to various embodiments, in the case of an SRS configured for UE positioning, a path-loss reference RS for a specific cell/BS/TRP may be configured at an SRS resource set level, open-loop power control may be performed, and power offset, etc. may be configured/indicated for each SRS resource.

For example, when a specific cell/BS/TRP configured/indicated as a path-loss reference RS to the UE is different from a specific cell/BS/TRP configured/indicated as spatial relation information, power may need to be adjusted to match a target cell/BS/TRP. For example, closed-loop power control performed at a resource set level may be changed to be performed at a resource level.

For example, the UE may be independently/exceptionally configured/indicated with a target reception power level of a receiving end (lower than a certain level) applied only in this case.

And/or, for example, the UE may be configured/indicated with an alpha value, which is a factor for compensating for path-loss applied only to this case, to a value lower than a certain level, and/or an exceptional alpha value may be defined/used.

For example, when the UE performs transmission of an SRS (normal/MIMO SRS) based on SRS-Config in an activated UL BWP (b) of a carrier (f) of a serving cell (c) using an SRS power control adjustment state based on index l, the UE may determine SRS transmission power P_{SRS,b,f,c}(i,qₛ,l) (dBm) in an SRS transmission occasion (i) based on Equation a below.

$${P}_{SRS , b , f , c} ( i , {q}_{s} , l ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} ) + {h}_{b , f , c} ( i , l )\end{matrix}\end{matrix} \} \qquad [ Equation ( a ) ]$$

For example, when the UE performs transmission of an SRS (positioning SRS) based on SRS-Positioning-Config in an activated UL BWP (b) of a carrier (f) of a serving) cell (c), the UE may determine SRS transmission power P_{SRS,b,f,c}(i,qₛ) (dBm) in an SRS transmission occasion (i) based on Equation b below.

$${P}_{SRS , b , f , c} ( i , {q}_{s} ) = min \{ \begin{matrix}{P}_{CMAX , f , c} ( i ) , \\ \begin{matrix}{P}_{O \_ SRS , b , f , c} ( {q}_{s} ) + 10 {log}_{10} ( {2}^{μ} \cdot {M}_{SRS , b , f , c} ( i ) ) + \\ {α}_{SRS , b , f , c} ( {q}_{s} ) \cdot {PL}_{b , f , c} ( {q}_{d} )\end{matrix}\end{matrix} \} \qquad [ Equation ( b ) ]$$

A more specific example of definition/configuration of each parameter and/or each method of power control included in the above-mentioned Equations (a) to (b) is described in 1.4. Uplink Power Control.

According to various embodiments, in the above-described SRS power control, a part h_{b,f,c}(i,l) may be introduced/configured for each resource. That is, according to various embodiments, a parameter related to closed-loop power control (and/or a part on which closed-loop power control is performed) may be configured/configured dependently on the SRS resource.

And/or, according to various embodiments, a power offset factor may be configured/introduced for each resource.

And/or, according to various embodiments, an alpha factor may be configured/introduced at a resource level.

Proposal ##: Indicate SRS Resource Muting in Specific SRS Transmission Occasion for Interference Control

According to various embodiments, the UE may be configured/indicated to transmit the SRS resource with zero power for a specific SRS transmission occasion of a specific SRS resource from a BS/location server/LMF. That is, according to various embodiments, the UE may be configured/indicated not to transmit the SRS resource in a specific SRS transmission occasion. That is, according to various embodiments, the UE may be configured/indicated with muting of a specific SRS resource in a specific SRS transmission occasion.

According to various embodiments, the SRS resource may be a periodic and/or semi-persistent SRS resource, and in particular, may be a positioning SRS resource configured for UE positioning.

According to various embodiments, that the SRS resource is not transmitted at a specific time may be understood as SRS muting.

And/or, according to various embodiments, partial zero-power transmission may be configured/indicated in such a way that transmission is not performed only on a specific symbol among several symbols configuring a specific SRS resource. According to various embodiments, with regard to the configuration, a time point when transmission is not performed for each resource at an SRS resource set level may be configured/indicated in a pattern based on time.

And/or, according to various embodiments, a specific offset value may be configured/indicated to be added to power control in such a way that an SRS is not transmitted in the above-described specific SRS transmission occasion. For example, an offset value for making a power value corresponding to a specific SRS transmission occasion to be 0 may be configured/indicated. For example, transmission power obtained/calculated from the UE at a specific time point by adding a specific factor may be configured/indicated to be 0.

Proposal ##: (Define/Change/Configure Open-Loop Equation Dependently on Cell/BS TRP)

According to various embodiments, an SRS transmission power control equation for an SRS transmission power control method may not be configured/defined in conjunction with/associated with a specific SRS resource set. For example, an SRS transmission power control method may be introduced/defined/configured as a function for an index/ID of a physical cell/BS/TRP.

According to various embodiments, assuming that the UE transmits an SRS to a specific physical cell/BS/TRP, the UE may configure/set a power control equation/method in conjunction with a specific physical cell/BS/TRP ID. For example, in the power control, a DL RS transmitted in a specific physical cell/BS/TRP corresponding to a specific physical cell/BS/TRP ID may be determined to be configured as a path-loss reference DL RS. And/or, for example, a power control equation/method may be linked/connected/indicated according to a target physical cell/BS/TRP of each SRS resource.

For example, it may be assumed that a DL RS transmitted from a physical cell/BS/TRP ID #0 and/or the physical cell/BS/TRP is linked with a configuration of spatial relation information of a specific SRS resource. For example, a direction of a TX beam used by the UE to transmit the SRS resource may be a physical cell/BS/TRP ID #0 (and/or determined/obtained based on physical cell/BS/TRP ID #0), and transmission power used for the SRS resource may be determined/obtained according to a power control equation determined/defined/configured for the physical cell/BS/TRP ID #0. For example, a specific DL RS transmitted from physical cell/BS/TRP ID #0 may be configured/indicated/included in the above equation.

That is, according to various embodiments, a TX beam may be determined for each SRS resource, and a transmission power control equation may be determined/defined/configured in conjunction with the beam direction.

And/or, according to various embodiments, power offset and/or closed-loop power control may be indicated/configured for each SRS resource. And/or, according to various embodiments, a factor related to a ratio compensating for path-loss (e.g., a parameter corresponding to alpha of Equations (a) to (b)) may be configured/indicated in conjunction with/associated with a specific cell/BS/TRP.

Hereinafter, in particular, various embodiments in terms of a procedure for a multi-cell RTT and/or UTDOA method will be described. However, various embodiments are not limited only to the multi-cell RTT and/or UTDOA method and may also be applied to another positioning method.

Proposal ##: Update of set of parameters

According to various embodiments, a parameter for a specific physical cell/BS/TRP ID may be updated at once.

According to various embodiments, a BS/location server/LMF may configure/indicate/update/reconfigure one or more of parameters, timing advance (TA), spatial relation information, and a QCL type related to power control as one set or a partial set at once in conjunction with a specific physical cell/BS/TRP ID.

For example, the BS/location server/LMF may (re)configure/indicate/update a set of parameters. For example, the set of parameters (and/or parameters included in the set of the parameters) may be linked/associated with a specific physical cell/BS/TRP ID. For example, the set of the parameters may include one or more of p0, alpha, path-loss reference RS, TA, spatial relation information, and QCL type-D.

For example, the spatial relation information and/or the QCL type may be configured for each SRS resource, the path-loss reference RS may be configured for each resource set, and a configured level may be different. That is, for example, the spatial relation information and/or the QCL type may be configured/indicated at an SRS resource level, and the path-loss reference RS may be configured/indicated at an SRS resource set level. Accordingly, according to various embodiments, backward compatibility or the like may be considered, a configuration/indication level may be considered, and splitting joint update/configuration parameters may be considered.

For example, it may be assumed that a TA is different for each specific physical cell/BS/TRP. In this case, for example, power control is configured/indicated for each SRS resource set, and thus configuration/indication/update at a resource set level may be considered.

For example, for a SRS resource set, the UE may be configured/indicated with {p0, alpha, path-loss reference RS, TA} from a cell/BS/TRP.

Proposal ##

According to various embodiments, a UL RS and a DL RS configured for Multi-RTT may be configured to be in conjunction with each other. For example, the specific SRS resource and/or the SRS resource set and the specific DL PRS resource and/or the DL PRS set may be linked/associated with each other.

For example, a DL PRS (a resource and/or a resource set) transmitted from a specific physical cell/BS/TRP (e.g., serving/neighboring physical cell/BS/TRP) is configured/indicated to the UE, a SRS (a resource and/or a resource set) transmitted to the physical cell/BS/TRP may be configured. According to various embodiments, the DL PRS resource and SRS resource transmitted in the specific serving/neighboring cell/BS/TRP may be configured to be linked/associated, and thus the UE may use a beam direction for receiving the DL PRS resource as a TX beam direction for transmitting the SRS resource. An operation of the UE according to various embodiments may be configured/indicated from the BS/location server/LMF.

And/or, according to various embodiments, considering that the PRS resource is transmitted from the specific serving/neighboring physical cell/BS/TRP, the DL PRS resource may be used as a path-loss reference for an SRS resource transmitted to the same serving/neighboring physical cell/BS/TRP.

According to various embodiments, for an operation of the UE according to various embodiments, the BS/location server/LMF may configure/indicate association for a PRS resource transmitted from a specific physical cell/BS/TRP and an SRS resource transmitted to the physical cell/BS/TRP to the UE. And/or, according to various embodiments, an SRS resource and/or a PRS resource configured/indicated to be dedicated for Multi-RTT-based UE positioning by the BS/location server/LMF may be used by the UE as a transceiving beam and/or a path-loss reference based on a target physical cell/BS/TRP to which the RS is transmitted (automatically and/or by default and/or without separate configuration). That is, according to various embodiments, a path-loss reference RS and/or a beam direction may be configured/indicated/defined based on a specific target physical cell/BS/TRP in an SRS resource configured to be dedicated to a Multi-RTT scheme.

And/or, according to various embodiments, for an SRS resource transmission time of an SRS resource transmitted to a specific cell/BS/TRP, the TA may be configured/indicated in conjunction with/associated with a specific physical cell/BS/TRP ID and/or SRS resource.

Proposal ##

According to various embodiments, considering that TAs are different for each physical cell/BS/TRP, multiple TAs linked to a specific cell/BS/TRP may be configured/indicated.

In more detail, for example, in relation to spatial relation information update/configuration and/or path-loss reference RS update/configuration, TA may be updated. That is, for example, an RS transmitted from a specific cell/BS/TRP may be set/indicated as a path-loss reference RS, and thus a TA value for the cell/BS/TRP may be configured/indicated together in conjunction with/associated with each other.

For example, a network may know information on a location of a physical cell at which the UE is located and/or a cell portion (which refers to a geographical part of a cell. The cell portion may be semi-persistent and may be the same for UL and DL. In a cell, the cell portion may be uniquely identified with a corresponding cell portion ID). For example, the network may recognize TA information required when the UE transmits an SRS to a specific cell/BS/TRP through a coarse location of the UE.

For example, considering that the TA is basically configured/indicated from the cell/BS/TRP to the UE, TA information to be applied when the UE performs transmission on the specific cell/BS/TRP may also be indicated to a cell/BS/TRP by a location server/LMF. For example, the cell/BS/TRP that receives TA information from the location server/LMF may inform the UE of the TA information.

According to various embodiments, the UE may be configured/indicated with TA in conjunction with a specific SRS resource. In particular, according to various embodiments, the UE may be configured with specific physical cell/BS/TRP index/ID information as spatial relation information for a specific SRS resource. According to various embodiments, the UE may be configured/indicated with TA information to be used when transmitting the SRS resource in conjunction with the physical cell/BS/TRP index/ID from the base station/location server/LMF.

For example, due to a TA value for different SRS resources transmitted to different physical cell/BS/TRPs as a target, a gap time/symbol may be required. That is, for example, due to a different TA for each cell/BS/TRP, when different SRSs are transmitted, the SRSs may overlap at a time when symbols are transmitted. In this case, for example, a necessary gap time/symbol between time points at which different SRS resources are transmitted may be required. According to various embodiments, the gap time/symbol may be configured/indicated from the BS/location server/LMF. According to various embodiments, due to the configuration of the gap time/symbol, a symbol configured/indicated with a specific SRS resource may be (automatically) changed after a specific gap time. According to various embodiments, the UE may recognize this. And/or, according to various embodiments, the UE may recognize that the symbol used for the SRS resource is changed by being offset by a gap time/symbol.

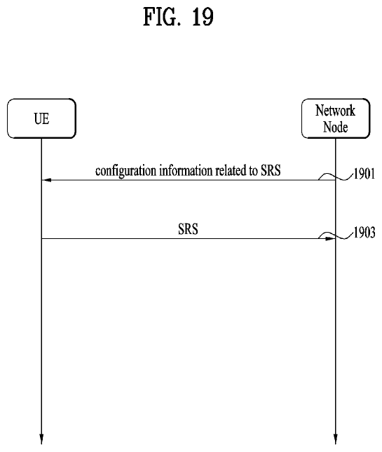

FIG. 19 is a diagram schematically illustrating a method of operating a UE and a network node according to various embodiments.

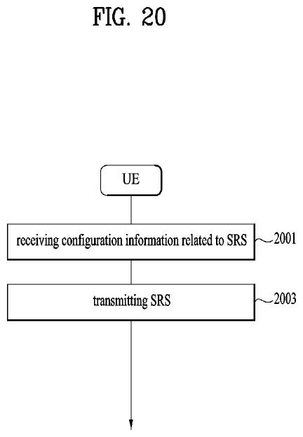

FIG. 20 is a flowchart illustrating a method of operating a UE according to various embodiments.

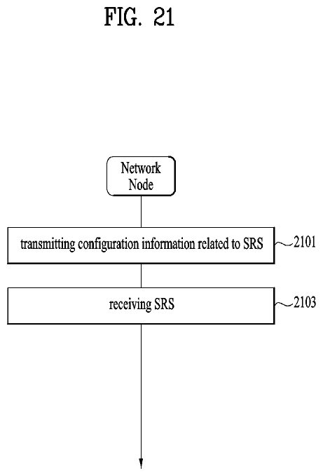

FIG. 21 is a flowchart illustrating a method of operating a network node according to various embodiments. For example, the network node may be a TP, a BS, a cell, a location server, an LMF, and/or any device performing the same work.

Referring to FIGS. 19 to 21, in steps 1901, 2001, and 2101 according to various embodiments, a network node may transmit configuration information related to a sounding reference signal (SRS), and the UE may receive the same.

In operations 1903, 2003, and 2103 according to various embodiments, the UE may transmit an SRS based on the configuration information, and the network node may receive the same.

According to various embodiments, transmission power of an SRS may be obtained based on path-loss.

According to various embodiments, path-loss may be obtained base on spatial relation information: based on a configuration of spatial relation information for a spatial relation between a downlink (DL) reference signal (RS) and an SRS.

Specific operations of the UE and/or the network node according to the above-described various embodiments may be described and performed based on Section 1 to Section 3 described before.

Since examples of the above-described proposal method may also be included in one of implementation methods of the various embodiments, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal).

4. Exemplary Configurations of Devices Implementing Various Embodiments

4.1. Exemplary Configurations of Devices to which Various Embodiments are Applied

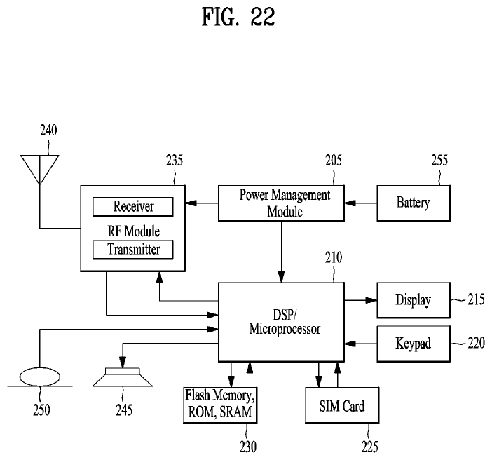

FIG. 22 is a diagram illustrating a device that implements various embodiments.

The device illustrated in FIG. 19 may be a UE and/or a BS (e.g., eNB or gNB or TP) and/or a location server (or LMF) which is adapted to perform the above-described mechanism, or any device performing the same operation.

Referring to FIG. 22, the device may include a digital signal processor (DSP)/microprocessor 210 and a radio frequency (RF) module (transceiver) 235. The DSP/microprocessor 210 is electrically coupled to the transceiver 235 and controls the transceiver 235. The device may further include a power management module 205, a battery 255, a display 215, a keypad 220, a SIM card 225, a memory device 230, an antenna 240, a speaker 245, and an input device 250, depending on a designer's selection.

Particularly, FIG. 22 may illustrate a UE including a receiver 235 configured to receive a request message from a network and a transmitter 235 configured to transmit timing transmission/reception timing information to the network. These receiver and transmitter may form the transceiver 235. The UE may further include a processor 210 coupled to the transceiver 235.

Further, FIG. 22 may illustrate a network device including a transmitter 235 configured to transmit a request message to a UE and a receiver 235 configured to receive timing transmission/reception timing information from the UE. These transmitter and receiver may form the transceiver 235. The network may further include the processor 210 coupled to the transceiver 235. The processor 210 may calculate latency based on the transmission/reception timing information.

A processor of a UE (or a communication device included in the UE) and/or a BS (or a communication device included in the BS) and/or a location server (or a communication device included in the location server) may operate by controlling a memory, as follows.

According to various embodiments, the UE or the BS or the location server may include at least one transceiver, at least one memory, and at least one processor coupled to the at least one transceiver and the at least one memory. The at least one memory may store instructions which cause the at least one processor to perform the following operations.

The communication device included in the UE or the BS or the location server may be configured to include the at least one processor and the at least one memory. The communication device may be configured to include the at least one transceiver or to be coupled to the at least one transceiver without including the at least one transceiver.

The TP and/or the BS and/or the cell and/or the location server and/or the LMF and/or any device performing the same operation may be referred to as a network node.

According to various embodiments, one or more processors included in a UE (one or more processors of a communication device included in the UE) may receive configuration information related to a sounding reference signal (SRS).

According to various embodiments, one or more processors included in a UE may transmit the SRS based on the configuration information.

According to various embodiments, transmission power of the SRS may be obtained based on path-loss.

According to various embodiments, when spatial relation information on a spatial relation between a downlink (DL) reference signal (RS) and the SRS is configured, the path-loss may be obtained based on the spatial relation information.

According to various embodiments, when the SRS is for positioning, path-loss reference configuration information is not included in the configuration information, and the spatial relation information is configured, the path-loss may be obtained based on the spatial relation information.

According to various embodiments, when the spatial relation information is configured, and an RS resource identified by the spatial relation information is not an SRS resource, the path-loss may be obtained based on the RS resource identified by the spatial relation information.

According to various embodiments, when the spatial relation information is configured and the RS resource identified by the spatial relation information is the SRS resource, or the spatial relation information is not configured, the path-loss may be obtained based on an RS resource obtained from a synchronization signal/physical broadcast channel (SS/PBCH) block of a serving cell used to obtain a master information block (MIB) by the device.

According to various embodiments, the path-loss may be obtained based on a path-loss reference.

According to various embodiments, the path-loss reference may be obtained based on the spatial relation information.

According to various embodiments, based on the spatial relation information is configured for one or more SRS resources that are some of SRS resources included in the SRS resource set, the path-loss reference may be used for all of the SRS resources.

According to various embodiments, the path-loss reference may be obtained based on an identifier (ID) of a transmission point (TP) at which the spatial relation information and the DL RS are received.

According to various embodiments, one or more processors included in a network node (one or more processors included in a communication device included in the network node) may transmit configuration information related to a sounding reference signal (SRS).

According to various embodiments, one or more processors included in a network node may receive the SRS in response to the configuration information.

According to various embodiments, transmission power of the SRS may be based on path-loss.

According to various embodiments, based on spatial relation information for a spatial relation between a downlink (DL) reference signal (RS) and the SRS is configured, the path-loss may be based on the spatial relation information.

Specific operations of the UE and/or the network node according to the above-described various embodiments may be described and performed based on Section 1 to Section 3 described before.

Unless contradicting each other, various embodiments may be implemented in combination. For example, (the processor included in) the UE and/or the network node according to various embodiments may perform operations in combination of the embodiments of the afore-described in Section 1 to Section 3, unless contradicting each other.

Example of Communication System to which Various Embodiments are Applied

In the present specification, various embodiments have been mainly described in relation to data transmission and reception between a BS and a UE in a wireless communication system. However, various embodiments are not limited thereto. For example, various embodiments may also relate to the following technical configurations.

The various descriptions, functions, procedures, proposals, methods, and/or operational flowcharts of the various embodiments described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

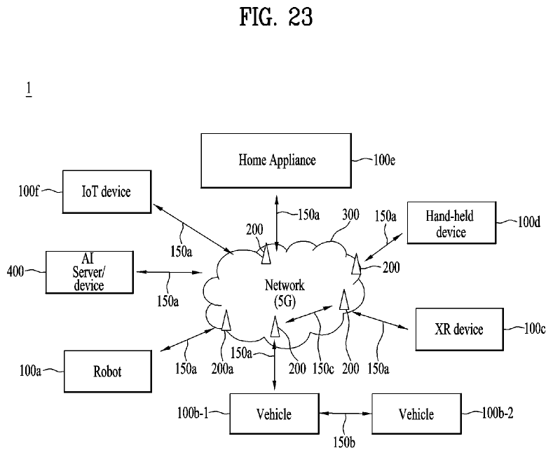

FIG. 23 illustrates an exemplary communication system to which various embodiments are applied.

Referring to FIG. 23, a communication system 1 applied to the various embodiments includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the various embodiments.

Example of Wireless Devices to which Various Embodiments are Applied

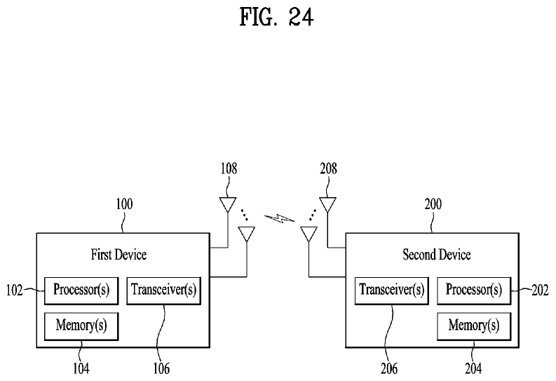

FIG. 24 illustrates exemplary wireless devices to which various embodiments are applicable.

Referring to FIG. 24, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. W1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the various embodiments, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the various embodiments, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

According to various embodiments, one or more memories (e.g., 104 or 204) may store instructions or programs which, when executed, cause one or more processors operably coupled to the one or more memories to perform operations according to various embodiments or implementations of the present disclosure.

According to various embodiments, a computer-readable storage medium may store one or more instructions or computer programs which, when executed by one or more processors, cause the one or more processors to perform operations according to various embodiments or implementations of the present disclosure.

According to various embodiments, a processing device or apparatus may include one or more processors and one or more computer memories connected to the one or more processors. The one or more computer memories may store instructions or programs which, when executed, cause the one or more processors operably coupled to the one or more memories to perform operations according to various embodiments or implementations of the present disclosure.

Example of Using Wireless Devices to which Various Embodiments are Applied

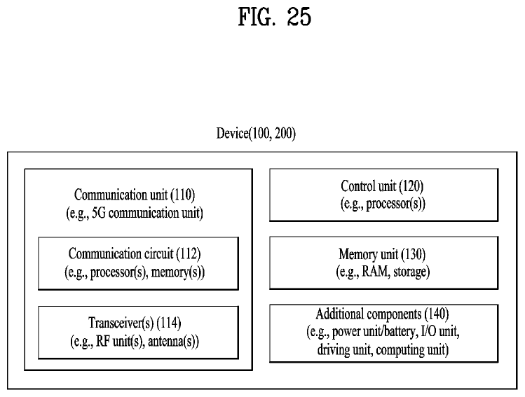

FIG. 25 illustrates other exemplary wireless devices to which various embodiments are applied. The wireless devices may be implemented in various forms according to a use case/service (see FIG. 23).

Referring to FIG. 25, wireless devices 100 and 200 may correspond to the wireless devices 100 and 200 of FIG. 23 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 23. For example, the transceiver(s) 114 may include the one or more transceivers 106 and 206 and/or the one or more antennas 108 and 208 of FIG. 23. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. W1), the vehicles (100b-1 and 100b-2 of FIG. W1), the XR device (100c of FIG. W1), the hand-held device (100d of FIG. W1), the home appliance (100e of FIG. W1), the IoT device (100f of FIG. W1), a digital broadcast terminal, a hologram device, a public safety device, an MTC device, a medicine device, a fintech device (or a finance device), a security device, a climate/environment device, the AI server/device (400 of FIG. W1), the BSs (200 of FIG. W1), a network node, etc. The wireless device may be used in a mobile or fixed place according to a use-example/service.

In FIG. 25, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 25 will be described in detail with reference to the drawings.

Example of Portable Device to which Various Embodiments are Applied

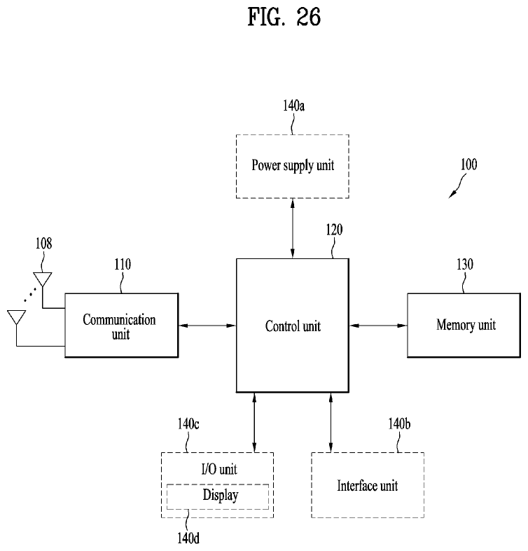

FIG. 26 illustrates an exemplary portable device to which various embodiments are applied. The portable device may be any of a smartphone, a smartpad, a wearable device (e.g., a smartwatch or smart glasses), and a portable computer (e.g., a laptop). A portable device may also be referred to as mobile station (MS), user terminal (UT), mobile subscriber station (MSS), subscriber station (SS), advanced mobile station (AMS), or wireless terminal (WT).

Referring to FIG. 26, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. X3, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the obtained information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

Example of Vehicle or Autonomous Driving Vehicle to which Various Embodiments.

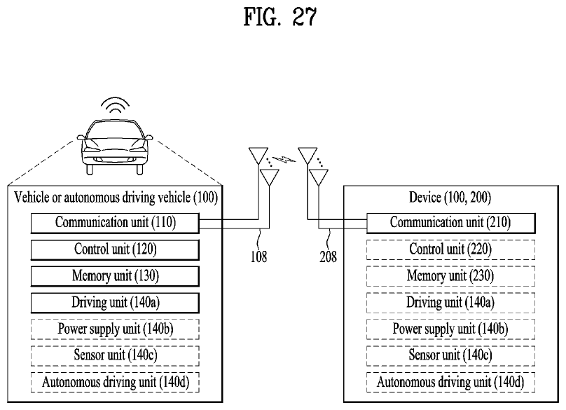

FIG. 27 illustrates an exemplary vehicle or autonomous driving vehicle to which various embodiments. The vehicle or autonomous driving vehicle may be implemented as a mobile robot, a car, a train, a manned/unmanned aerial vehicle (AV), a ship, or the like.

Referring to FIG. 27, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. X3, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

In summary, various embodiments may be implemented through a certain device and/or UE.

For example, the certain device may be any of a BS, a network node, a transmitting UE, a receiving UE, a wireless device, a wireless communication device, a vehicle, a vehicle equipped with an autonomous driving function, an unmanned aerial vehicle (UAV), an artificial intelligence (AI) module, a robot, an augmented reality (AR) device, a virtual reality (VR) device, and other devices.

For example, a UE may be any of a personal digital assistant (PDA), a cellular phone, a personal communication service (PCS) phone, a global system for mobile (GSM) phone, a wideband CDMA (WCDMA) phone, a mobile broadband system (MBS) phone, a smartphone, and a multi mode-multi band (MM-MB) terminal.

A smartphone refers to a terminal taking the advantages of both a mobile communication terminal and a PDA, which is achieved by integrating a data communication function being the function of a PDA, such as scheduling, fax transmission and reception, and Internet connection in a mobile communication terminal. Further, an MM-MB terminal refers to a terminal which has a built-in multi-modem chip and thus is operable in all of a portable Internet system and other mobile communication system (e.g., CDMA 2000, WCDMA, and so on).

Alternatively, the UE may be any of a laptop PC, a hand-held PC, a tablet PC, an ultrabook, a slate PC, a digital broadcasting terminal, a portable multimedia player (PMP), a navigator, and a wearable device such as a smartwatch, smart glasses, and a head mounted display (HMD). For example, a UAV may be an unmanned aerial vehicle that flies under the control of a wireless control signal. For example, an HMD may be a display device worn around the head. For example, the HMD may be used to implement AR or VR.

The wireless communication technology in which various embodiments are implemented may include LTE, NR, and 6G, as well as narrowband Internet of things (NB-IoT) for low power communication. For example, the NB-IoT technology may be an example of low power wide area network (LPWAN) technology and implemented as the standards of LTE category (CAT) NB1 and/or LTE Cat NB2. However, these specific appellations should not be construed as limiting NB-IoT. Additionally or alternatively, the wireless communication technology implemented in a wireless device according to various embodiments may enable communication based on LTE-M. For example, LTE-M may be an example of the LPWAN technology, called various names such as enhanced machine type communication (eMTC). For example, the LTE-M technology may be implemented as, but not limited to, at least one of 1) LTE CAT 0, 2) LTE Cat M1, 3) LTE Cat M2, 4) LTE non-bandwidth limited (non-BL), 5) LTE-MTC, 6) LTE machine type communication, and/or 7) LTE M. Additionally or alternatively, the wireless communication technology implemented in a wireless device according to various embodiments may include, but not limited to, at least one of ZigBee, Bluetooth, or LPWAN in consideration of low power communication. For example, ZigBee may create personal area networks (PANs) related to small/low-power digital communication in conformance to various standards such as IEEE 802.15.4, and may be referred to as various names

Various embodiments may be implemented in various means. For example, various embodiments may be implemented in hardware, firmware, software, or a combination thereof.

In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the methods according to the various embodiments may be implemented in the form of a module, a procedure, a function, etc. performing the above-described functions or operations. A software code may be stored in the memory 50 or 150 and executed by the processor 40 or 140. The memory is located at the interior or exterior of the processor and may transmit and receive data to and from the processor via various known means.

Those skilled in the art will appreciate that the various embodiments may be carried out in other specific ways than those set forth herein without departing from the spirit and essential characteristics of the various embodiments. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. It is obvious to those skilled in the art that claims that are not explicitly cited in each other in the appended claims may be presented in combination as an embodiment of the present disclosure or included as a new claim by a subsequent amendment after the application is filed.

### INDUSTRIAL AVAILABILITY

The various embodiments are applicable to various wireless access systems including a 3GPP system, and/or a 3GPP2 system. Besides these wireless access systems, the various embodiments are applicable to all technical fields in which the wireless access systems find their applications. Moreover, the proposed method can also be applied to mmWave communication using an ultra-high frequency band.

1. A method performed by a device in a wireless communication system, the method comprising:
receiving configuration information related to a sounding reference signal (SRS); and
transmitting the SRS based on the configuration information,
wherein transmission power of the SRS is obtained based on path-loss, and
wherein based on spatial relation information regarding a spatial relation between a downlink (DL) reference signal (RS) and the SRS being configured, the path-loss is obtained based on the spatial relation information.

2. The method of claim 1, wherein based on (i) the SRS being for positioning, (ii) path-loss reference configuration information being not included in the configuration information, and (iii) the spatial relation information being configured, the path-loss is obtained based on the spatial relation information.

3. The method of claim 1, wherein based on (i) the spatial relation information being configured and (ii) an RS resource identified by the spatial relation information being not an SRS resource, the path-loss is obtained based on the RS resource identified by the spatial relation information, and
wherein based on (i) the spatial relation information being configured and (ii) an RS resource identified by the spatial relation information being the SRS resource, or the spatial relation information being not configured, the path-loss is obtained based on an RS resource obtained from a synchronization signal/physical broadcast channel (SS/PBCH) block of a serving cell used to obtain a master information block (MIB) by the device.

4. The method of claim 1, wherein the path-loss is obtained based on a path-loss reference, and
wherein the path-loss reference is obtained based on the spatial relation information.

5. The method of claim 4, wherein based on the spatial relation information being configured for at least one SRS resource that is some of SRS resources included in the SRS resource set, the path-loss reference is used for all of the SRS resources.

6. The method of claim 4, wherein the path-loss reference is obtained based on an identifier (ID) of a transmission point (TP) at which the spatial relation information and the DL RS are received.

7. A user equipment (UE) operating in a wireless communication system,
the UE comprising:
a transceiver; and
at least one processor coupled with the transceiver,
wherein the at least one processor is configured to:
receive configuration information related to a sounding reference signal (SRS); and
transmit the SRS based on the configuration information,
wherein transmission power of the SRS is obtained based on path-loss, and
wherein, based on spatial relation information for a spatial relation between a downlink (DL) reference signal (RS) and the SRS is configured, the path-loss is obtained based on the spatial relation information.

8. The UE of claim 7, wherein based on (i) the SRS being for positioning, (ii) path-loss reference configuration information being not included in the configuration information, and (iii) the spatial relation information being configured, the path-loss is obtained based on the spatial relation information.

9. The UE of claim 7, wherein based on (i) the spatial relation information being configured and (ii) an RS resource identified by the spatial relation information being not an SRS resource, the path-loss is obtained based on the RS resource identified by the spatial relation information, and
wherein based on (i) the spatial relation information being configured and (ii) an RS resource identified by the spatial relation information being the SRS resource, or the spatial relation information being not configured, the path-loss is obtained based on an RS resource obtained from a synchronization signal/physical broadcast channel (SS/PBCH) block of a serving cell used to obtain a master information block (MIB) by the device.

10. The UE of claim 7, wherein the path-loss is obtained based on a path-loss reference, and
wherein the path-loss reference is obtained based on the spatial relation information.

11. The UE of claim 7, wherein the at least one processor is configured to communicate with at least one of a mobile terminal, a network, and an autonomous driving vehicle other than a vehicle including the UE.

12. A method performed by a device in a wireless communication system, the method comprising:
transmitting configuration information related to a sounding reference signal (SRS); and
receiving the SRS in response to the configuration information,
wherein transmission power of the SRS is based on path-loss, and
wherein based on spatial relation information for a spatial relation between a downlink (DL) reference signal (RS) and the SRS is configured, the path-loss is based on the spatial relation information.

13. A base station (BS) operating in a wireless communication system, the BS comprising:
a transceiver; and
at least one processor coupled with the transceiver,
wherein the at least one processor is configured to:
transmit configuration information related to a sounding reference signal (SRS); and
receive the SRS in response to the configuration information,
wherein transmission power of the SRS is based on path-loss, and
wherein based on spatial relation information for a spatial relation between a downlink (DL) reference signal (RS) and the SRS is configured, the path-loss is based on the spatial relation information.

14. (canceled)

15. (canceled)
